(19) United States
(12) Patent Application Publication
(10) Pub. No.: US 2026/0363256 A1
(43) Pub. Date: Nov. 19, 2026

(54) IMPROVED BARRIER COATING FOR PRODUCE

(71) Applicant: Nabaco Inc., San Marcos, TX (US)

(72) Inventors: Gary BEALL, San Marcos, TX (US); Maedah AMIRI, San Marcos, TX (US)

(21) Appl. No.: 19/488,239

(22) PCT Filed: May 24, 2024
(86) PCT No.: PCT/US2024/031097

§ 371 Date: Nov. 26, 2025

Related U.S. Application Data
(60) Provisional application No. 63/469,094, filed on May 26, 2023.
(60) Provisional application No. 63/469,091, filed on May 26, 2023.

(51) Int. Cl. A23B 2/771; A23B 7/154

(52) U.S. Cl. CPC A23B 2/771; A23B 7/154

(57) ABSTRACT

Thixotropic aqueous mixtures are provided that form a very thin coating on fruits and vegetables that extend the shelf life and ready to eat window with much lower concentration and dose than previous technology. The mixtures comprise at least one smectite clay and a glycerophospholipid, and optionally a water-soluble polymer, added with high shear mixing to water then applied to produce via a tank, spray bar, or brush bed or combination thereof.

### FIELD OF THE INVENTION

The present invention is generally directed toward compositions that increase the shelf life and ready to eat window of produce such as fruits and vegetables. The compositions form a coating on the surface of the produce that improves one or more barrier properties of the produce surface, in particular gas barrier efficacy, as compared to uncoated produce, thereby protecting the produce from dehydration and/or oxidation which reduce shelf life and ready to eat window of the produce. The invention also relates to methods for making the compositions. The invention further provides methods for coating produce (such as fruits), comprising applying the coating composition to the produce, and methods and uses for improving the efficacy of barrier coatings to extend shelf life of coated fruits and vegetables.

### BACKGROUND OF THE INVENTION

Fruits and vegetables suffer from limited shelf life and ready to eat windows, which are impacted by dehydration and exposure to oxygen in the air. Climacteric fruits, including apples, pears, and avocados, continue to ripen post-harvest. The production of ethylene, coupled with an increased respiration rate, contributes to faster ripening and thereby reduces shelf life and ready to eat window. Fruits and vegetables are frequently stored for long periods of time and are often shipped long distances prior to their final point of sale to the consumer. This can lead to problems if the produce ripens quickly. Overripe or damaged fruits and vegetables often cannot be sold or consumed, resulting in large amounts of food waste. Therefore, it would be desirable to improve the shelf life of produce by increasing the length of time that the produce may be stored prior to consumption, by preventing premature ripening, damage, and/or spoilage of the produce.

One approach to lowering dehydration is the use of waxes to coat fruit. Fruits and vegetables are commonly coated with waxes or shellac to give a glossy sheen to the fruit and retain moisture. This practice is heavily utilized for apples, avocados and cucumbers. These traditional coatings do not improve shelf life of the produce and do little to protect the fruit from oxidation. The wax coatings are also expected to act as a carrier for fungicides and pesticides that have been applied to the produce, and cause undesirable taste and texture in the produce (particularly fruit), which may be off-putting to the consumer. Wax coatings are not easily removed from the produce surface by the consumer, and may also build up on the packing line.

It has recently been demonstrated that the coating of fruit with an aqueous mixture of select smectite clay and the proper polymer will self-assemble into a nanocomposite barrier coating on the surface of the fruit or vegetable. This coating does a good job of protecting the fruit from oxidation and dehydration. When applied to fruit via a dip tank, these self-assembling barrier coatings yield good shelf life extension, doubling or tripling the shelf life of produce. However, this approach requires the concentration and dose of the coating on the fruit to be high, which can lead to anaerobic conditions that are very bad for fruit taste and ripening. The higher concentration also leads to application problems due to viscosity. These thick coatings can separate from the fruit and flake off. They are also fairly expensive.

Thus, a need exists in the art for an additive that improves the efficacy of these barrier coatings at much lower concentration and dose, and for a thinner barrier coating that also extends the shelf life of the produce.

### SUMMARY OF THE INVENTION

The invention relates generally to compositions, methods, and uses for protecting produce from dehydration and/or oxidation, or for delaying ripening of produce. The methods involve coating the produce with a thixotropic aqueous mixture as described herein. The terms “thixotropic aqueous mixture” and “thixotropic aqueous composition” (or more generally “thixotropic mixture” and “thixotropic composition”) are used interchangeably herein to refer to compositions and mixtures of the invention that are thixotropic.

According to a first aspect of the invention, there is provided a thixotropic aqueous mixture for protecting produce from dehydration and/or oxidation, comprising: a) smectite clay; and b) a glycerophospholipid.

The invention also provides methods of making a thixotropic aqueous mixture of the invention, and thixotropic aqueous mixtures made by the methods of the invention. The methods of the invention generally comprise at least one mixing step performed under high shear. Therefore, according to a second aspect of the invention, there is provided a method of making a thixotropic aqueous mixture, comprising mixing at least one smectite clay and a glycerophospholipid with water under high shear to form the thixotropic aqueous mixture. In some embodiments, the method further comprises applying the thixotropic aqueous mixture to the surface of produce.

Applying a coating of the thixotropic aqueous mixture of the invention to the surface of produce confers one or more advantageous properties, as described herein. In this regard, coating the surface of produce with a thixotropic aqueous mixture of the invention improves one or more barrier properties of the produce surface, as compared to a surface of the produce that is not coated with a thixotropic aqueous mixture of the invention. For example, it is contemplated that coating the surface of produce with a thixotropic aqueous mixture of the invention creates a barrier between the produce surface and the external environment that reduces the transfer of gas and/or moisture though the surface, as compared to an uncoated surface, thereby reducing oxidation, respiration, transpiration, moisture loss, and/or dehydration. Any one of more of these barrier properties may contribute to improvements in shelf life and/or ready to eat window of produce.

Therefore, the invention provides methods and uses for protecting produce from dehydration and/or oxidation, and/or for delaying ripening of produce. Accordingly, in a third aspect, the invention provides a method of protecting produce from dehydration and/or oxidation, comprising applying a thixotropic aqueous mixture of the invention to the surface of the produce; and a method of delaying ripening of produce, comprising applying a thixotropic aqueous mixture of the invention to the surface of the produce, whereby ripening of the produce is delayed compared to ripening of uncoated produce. The methods of the invention generally comprise application of the thixotropic aqueous mixture to the surface of the produce using a technique that imparts high shear.

The invention also provides uses of the thixotropic aqueous mixture of the invention. Thus, in a fifth aspect, the invention provides the use of the thixotropic aqueous mixture of the invention for protecting produce from dehydration and/or oxidation, and further provides the use of the thixotropic aqueous mixture of the invention for delaying ripening of produce.

### BRIEF DESCRIPTION OF THE DRAWINGS

FIG. 1 is a photograph showing the degree of ripening (change from green to paler, yellow color) observed in Argentina Packham pears coated in a thixotropic 4.5% aqueous dispersion containing 0.945% bentonite, 1.48% polyvinyl alcohol, 1.89% lecithin, and 0.18% sodium citrate (lower photograph), compared to “Control” Argentina Packham pears lacking any coating (upper photograph), at seven days post-application. It can be observed that the coated pears better retained an appealing green color and also showed less signs of damage on the skin, compared to the uncoated control pears.

FIG. 2 depicts percentage weight loss in organic Gala apples, coated with thixotropic coatings of the invention, compared to “Control” Gala apples (uncoated), at 24 days post-application. It can be observed that coating apples with a thixotropic aqueous mixture of the invention results in a significant reduction in % weight loss, as compared to the same variety of apples that are uncoated.

FIG. 3 depicts percentage weight loss in conventional (i.e., non-organic) Bartlett pears, coated with thixotropic coatings of the invention, compared to “Control” Bartlett pears (uncoated), at 9 days post-application. It can be observed that coating pears with a thixotropic aqueous mixture of the invention results in a significant reduction in % weight loss, as compared to the same variety of pears that are uncoated.

FIG. 4 depicts percentage weight loss in lemons coated with thixotropic coatings of the invention, compared to “Control” lemons (uncoated), at 7 days post-application. It can be observed that coating lemons with a thixotropic aqueous mixture of the invention results in a significant reduction in % weight loss, as compared to uncoated lemons.

FIG. 5 depicts percentage weight loss in lemons, coated with thixotropic coatings of the invention compared to “Control” lemons (uncoated), at 7 days post-application. It can be observed that coating lemons with a thixotropic aqueous mixture of the invention results in a significant reduction in % weight loss, as compared to uncoated lemons.

FIG. 6 depicts percentage weight loss in mandarins, coated with thixotropic coatings of the invention compared to “Control” mandarins (uncoated), at 7 days post-application. It can be observed that coating mandarins with a thixotropic aqueous mixture of the invention results in a significant reduction in % weight loss, as compared to uncoated mandarins.

FIG. 7 depicts percentage weight loss in mandarins, coated with thixotropic coatings of the invention compared to “Control” mandarins (uncoated), at 7 days post-application. It can be observed that coating mandarins with a thixotropic aqueous mixture of the invention results in a significant reduction in % weight loss, as compared to uncoated mandarins.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

It has been unexpectedly discovered that coating the surface of produce (e.g., the skin, rind, or peel of produce) with a thixotropic aqueous mixture of the invention improves one or more barrier properties of the produce surface, as compared to a surface of the produce that is not coated with a thixotropic aqueous mixture of the invention (i.e., an “uncoated” surface/“uncoated produce”). As used herein, the term “uncoated” encompasses a surface that lacks any coating and also encompasses a surface that is coated with a conventional barrier coating, such as a wax-based coating. Therefore, a produce surface that is not coated with a thixotropic aqueous mixture of the invention (i.e., “uncoated”) may have a different coating, or may have no coating of any kind. It is contemplated, for example, that coating the surface of produce with a thixotropic aqueous mixture of the invention creates a barrier between the produce surface and the external environment that reduces the transfer of gas and/or moisture though the surface, as compared to an uncoated surface. Therefore, when coated on the surface of produce, the thixotropic aqueous mixture of the invention may act as a gas and/or moisture (e.g., water vapor) barrier. By reducing the transfer of gases, including oxygen and carbon dioxide, through the produce surface, the thixotropic aqueous mixture of the invention may reduce the produce respiration rate, and slow down the effects of ethylene on produce ripening. By reducing the transfer of atmospheric oxygen though the produce surface, the thixotropic aqueous mixture of the invention may protect the produce against oxidation. Further, by reducing the loss of moisture, including water, though the produce surface, the thixotropic aqueous mixture of the invention may protect the produce against transpiration and/or dehydration. Any one of more of these barrier properties may contribute to improvements in shelf life and/or ready to eat window of produce.

In a first aspect, the invention provides a thixotropic aqueous mixture comprising: a) smectite clay; and b) a glycerophospholipid.

The thixotropic aqueous mixture is for (suitable and effective for) protecting produce from dehydration and/or oxidation. The thixotropic aqueous mixture is also for (suitable and effective for) delaying ripening of produce coated with the mixture, as compared to uncoated produce. Further, the thixotropic aqueous mixture is for (suitable and effective for) maintaining or extending the shelf life of produce coated with the mixture, as compared to uncoated produce. The thixotropic aqueous mixture is also for (suitable and effective for) forming a barrier coating on the surface of produce, which improves one or more barrier properties (e.g., gas barrier properties) of the produce surface to which it is applied, as compared to an uncoated surface of the same (type of) produce. Accordingly, the thixotropic aqueous mixture may be referred to as a coating composition, and optionally a barrier coating composition, such as a gas and/or moisture barrier coating composition. When applied to the surface of produce, the thixotropic aqueous mixture of the invention forms a coating that acts as a barrier to the transfer of gas and/or moisture through the produce surface. Therefore, a coating of the thixotropic aqueous mixture of the invention may be referred to as a barrier coating, such as a gas and/or moisture barrier coating.

The term “thixotropic”, as used herein, refers to mixtures having non-Newtonian fluid dynamics whose flow properties, such as apparent viscosity, change with shear rate and duration of shear. The thixotropy of the aqueous mixture is critical for achieving one or more of the desired barrier properties, and thereby protection from dehydration and/or oxidation, when coated on the surface of produce. The high shear imparted during preparation of the mixture and/or during application of the mixture to the surface of the produce lowers the viscosity of the thixotropic aqueous mixture and lessens the resistance to flow. For example, when spraying the coating mixture onto the surface of produce using a spray bar, the shear imparted by the pump and spray nozzles lowers the viscosity of the aqueous thixotropic mixture and lessens the resistance to flow during spraying (i.e., the thixotropic mixture is thin when is it dispensed through the spray nozzle). Using a high shear application method, the amount of produce that can be coated using a defined volume of mixture is far higher than the amount of produce that can be coated with the same volume of mixture using a non-high shear method such as dipping. For example, 1 liter of a thixotropic aqueous mixture of the invention can be used to coat 500 pounds of produce when applied via a dip tank, but up to 7000 pounds of produce when applied via a spray bar. Once the spray impinges upon the surface of the produce, the viscosity of the thixotropic aqueous mixture recovers, and the thixotropic aqueous mixture forms a coating or film on the surface of the produce. A brush bed may be used to further smooth out the coating on the surface of the produce, making the coating more comprehensive. Moreover, brushing reorientates the platelets of the smectite clay to be parallel to the surface of the produce (i.e., aligned with the surface of the produce), which reinforces the coating.

The thixotropic aqueous mixture of the invention comprises smectite clay. Any smectite clay can be used in the thixotropic aqueous mixture of the invention. For example, it is contemplated that the smectite clay is at least one of montmorillonite, bentonite, hectorite, or Laponite (lithium sodium magnesium silicate, Na_{0.7}Si₈Mg_{5.5}Li_{0.3}O₂₀(OH)₄), or any combination thereof. Particularly good results have been achieved using montmorillonite, Laponite, bentonite, or a combination of montmorillonite and Laponite. Thus, in some embodiments, the thixotropic aqueous mixture of the invention comprises montmorillonite and/or Laponite. In some embodiments, the thixotropic aqueous mixture of the invention comprises bentonite. When dispersed in water, smectite clays form a colloidal dispersion, which may be translucent or even transparent.

It is contemplated that the smectite clay is present in the thixotropic aqueous mixture in an amount from, for example, 0.5 to 6.5 wt. %, optionally from 1.0 to 5.0 wt. %, optionally from 1.0 to 1.5 wt. %. Thus, in some embodiments, the invention provides a thixotropic aqueous mixture comprising: a) smectite clay in an amount from 0.5 to 6.5 wt. %, such as from 1.0 to 5.0 wt. %, such as from 1.0 to 1.5 wt. %; and b) a glycerophospholipid. For example, in some embodiments, the thixotropic aqueous mixture comprises: a) smectite clay in an amount of about 1.0 to 1.5 wt. %; and b) a glycerophospholipid. In any of these embodiments, the smectite clay may be montmorillonite, Laponite, or bentonite, or montmorillonite and Laponite.

The thixotropic aqueous mixture of the invention also comprises a glycerophospholipid. In particular, it is contemplated that the thixotropic aqueous mixture of the invention comprises a lecithin. Lecithins are mixtures of glycerophospholipids, including phosphatidylcholine, phosphatidylethanolamine, phosphatidylinositol, phosphatidylserine, and phosphatidic acid. Common sources of lecithin include egg yolk, marine foods, soybeans, milk, rapeseed, cottonseed, and sunflower oil. The exact composition of a lecithin depends on its origin. Therefore, in some embodiments, the thixotropic aqueous mixture of the invention comprises smectite clay and lecithin. The lecithin may, for example, be (or be derived from) sunflower lecithin, soy lecithin, or egg lecithin. Sunflower and soy lecithin are vegan, which may be beneficial in order to maintain the vegan status of fruit and vegetable produce to which the thixotropic aqueous mixture is applied.

It is contemplated that the glycerophospholipid (e.g., lecithin) is present in the thixotropic aqueous mixture in an amount from, for example, 0.5 to 4.0 wt. %, optionally from 1.5 to 3.5 wt. %, optionally from 1.5 to 2.5 wt. %, optionally in an amount of (or of about) 2 wt. %. Therefore, in some embodiments, the thixotropic aqueous mixture of the invention comprises a) smectite clay and b) a glycerophospholipid in an amount from, for example, 0.5 to 4.0 wt. %, such as 1.5 to 3.5 wt. %, such as 1.5 to 2.5 wt. %, such as about 2 wt. %. In some embodiments, the thixotropic aqueous mixture of the invention comprises a) smectite clay and b) lecithin in an amount from, for example, 0.5 to 4.0 wt. %, such as 1.5 to 3.5 wt. %, such as 1.5 to 2.5 wt. %, such as about 2 wt. %. For example, in some embodiments, the thixotropic aqueous mixture of the invention comprises a) smectite clay and b) lecithin in an amount of about 2 wt. %.

Accordingly, it is contemplated that a thixotropic aqueous mixture of the invention comprises: a) smectite clay in an amount from 0.5 to 6.5 wt. %, such as from 1.0 to 5.0 wt. %, such as from 1.0 to 1.5 wt. %; and b) a glycerophospholipid in an amount from 0.5 to 4.0 wt. %, such as 1.5 to 3.5 wt. %, such as 1.5 to 2.5 wt. %, such as about 2 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; and b) lecithin in an amount from 0.5 to 4.0 wt. %, such as 1.5 to 3.5 wt. %, such as 1.5 to 2.5 wt. %, such as about 2 wt. %. In some embodiments, a thixotropic aqueous mixture of the invention comprises: a) smectite clay in an amount from 1.0 to 1.5 wt. %; and b) a glycerophospholipid (e.g., lecithin) in an amount of about 2 wt. %. In any of these embodiments, the smectite clay may be montmorillonite, Laponite, bentonite, or a combination of montmorillonite and Laponite.

In some embodiments, the ratio of the smectite clay to the glycerophospholipid (e.g., lecithin) is between 3:1 and 0.3:1 (w/w); optionally between 3:1 and 1:1, such as about 1.4:1; or optionally between 1.5:1 and 0.5:1 (w/w), such as between 1:1 and 0.5:1, or between 0.7:1 and 0.5:1; optionally about 0.7:1 or 0.6:1. For example, a thixotropic aqueous mixture of the invention may comprise smectite clay:lecithin in a ratio of about 0.7:1.

The thixotropic aqueous mixture may further comprise an antioxidant. The inclusion of an antioxidant is useful when it is desired to limit oxidation of the produce. In some embodiments, the antioxidant is or comprises sodium citrate. Sodium citrate also acts as a deflocculant, which is useful when the mixture is prepared using hard water, which flocculates the coating. Therefore, in some embodiments, a thixotropic aqueous mixture of the invention comprises smectite clay, a glycerophospholipid, and sodium citrate. For example, the thixotropic aqueous mixture may comprise smectite clay, lecithin, and sodium citrate.

It is contemplated that the antioxidant, optionally sodium citrate, is present in any of the thixotropic aqueous mixtures of the invention in an amount from 0.05 to 0.5 wt. %, optionally from 0.1 to 0.3 wt. %., optionally in an amount of (or of about) 0.2 or 0.25 wt. %.

Accordingly, it is contemplated that a thixotropic aqueous mixture of the invention comprises: a) smectite clay in an amount from 0.5 to 6.5 wt. %, such as from 1.0 to 5.0 wt. %, such as from 1.0 to 1.5 wt. %; b) a glycerophospholipid in an amount from 0.5 to 4.0 wt. %, such as 1.5 to 3.5 wt. %, such as 1.5 to 2.5 wt. %, such as about 2 wt. %; and c) an antioxidant in an amount from 0.05 to 0.5 wt. %, such as 0.1 to 0.3 wt. %., such as about 0.2 or 0.25 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; and c) an antioxidant in an amount from 0.05 to 0.5 wt. %, such as 0.1 to 0.3 wt. %., such as about 0.2 or 0.25 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; and c) sodium citrate in an amount from 0.05 to 0.5 wt. %, such as 0.1 to 0.3 wt. %., such as about 0.2 or 0.25 wt. %. In some embodiments, a thixotropic aqueous mixture of the invention comprises: a) smectite clay in an amount from 1.0 to 1.5 wt. %; and b) lecithin in an amount of about 2 wt. %; and sodium citrate in an amount of about 0.2 or 0.25 wt. %. In any of these embodiments, the smectite clay may be montmorillonite, Laponite, bentonite, or a combination of montmorillonite and Laponite.

In some embodiments, a thixotropic aqueous mixture of the invention comprises montmorillonite in amount from 0.45 to 6.5 wt. % (e.g., about 5.0 or 6.0 wt. %), lecithin in an amount from 2.0 to 4.0 wt. %, and sodium citrate in an amount of about 0.2 wt. %. Other thixotropic aqueous mixtures of the invention comprise montmorillonite in amount from 1.0 to 1.5 wt. %, lecithin in an amount of about 2 wt. %; and sodium citrate in an amount of about 0.2 wt. %.

The thixotropic aqueous mixture may further comprise one or more water-soluble polymers. Suitable water-soluble polymers for inclusion in the thixotropic aqueous mixtures of the invention include synthetic water-soluble polymers, semi-synthetic water-soluble polymers, or natural water-soluble polymers.

One example of a synthetic water-soluble polymer useful in the invention is polyvinyl alcohol (PVOH). Thus, in some embodiments, a thixotropic aqueous mixture of the invention comprises PVOH. For example, a thixotropic aqueous mixture of the invention may comprise: a) smectite clay; b) lecithin; and c) PVOH. In some embodiments, a thixotropic aqueous mixture of the invention may comprise: a) smectite clay; b) lecithin; c) PVOH; and d) an antioxidant, optionally sodium citrate. For example, a thixotropic aqueous mixture of the invention may comprise: a) Laponite; b) lecithin; c) PVOH; and d) sodium citrate; such as a) montmorillonite and Laponite; b) lecithin; c) PVOH; and d) sodium citrate; or a thixotropic aqueous mixture of the invention may comprise: a) bentonite; b) lecithin; c) PVOH; and d) sodium citrate.

It is contemplated that PVOH is present in any of the thixotropic aqueous mixtures of the invention in an amount from 1.0 to 3.0 wt. %, optionally from 1.5 to 2.5 wt. %, optionally at about 2.0 wt. %. Therefore, in some embodiments, a thixotropic aqueous mixture of the invention comprises: a) smectite clay; b) a glycerophospholipid; and c) PVOH in an amount from 1.0 to 3.0 wt. %, such as from 1.5 to 2.5 wt. %, such as about 2.0 wt. %. For example, the thixotropic aqueous mixture of the invention may comprise: a) smectite clay; b) lecithin; and c) PVOH in an amount from 1.0 to 3.0 wt. %, such as from 1.5 to 2.5 wt. %, such as about 2.0 wt. %. In any of these embodiments, the thixotropic aqueous mixture of the invention may further comprise an antioxidant, such as sodium citrate.

Accordingly, it is contemplated that a thixotropic aqueous mixture of the invention comprises: a) smectite clay in an amount from 0.5 to 6.5 wt. %, such as from 1.0 to 5.0 wt. %, such as from 1.0 to 1.5 wt. %; b) a glycerophospholipid in an amount from 0.5 to 4.0 wt. %, such as 1.5 to 3.5 wt. %, such as 1.5 to 2.5 wt. %, such as about 2 wt. %; and c) PVOH in an amount from 1.0 to 3.0 wt. %, such as from 1.5 to 2.5 wt. %, such as about 2.0 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; and c) PVOH in an amount from 1.0 to 3.0 wt. %, such as from 1.5 to 2.5 wt. %, such as about 2.0 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; c) PVOH in an amount from 1.0 to 3.0 wt. %, such as from 1.5 to 2.5 wt. %, such as about 2.0 wt. %; and d) an antioxidant, optionally sodium citrate, in an amount from 0.05 to 0.5 wt. %, such as 0.1 to 0.3 wt. %., such as about 0.2 or 0.25 wt. %. In some embodiments, a thixotropic aqueous mixture of the invention comprises: a) smectite clay in an amount from 1.0 to 1.5 wt. %; and b) lecithin in an amount of about 2 wt. %; c) PVOH in an amount of about 2.0 wt. %; and sodium citrate in an amount of about 0.2 or 0.25 wt. %. In any of these embodiments, the smectite clay may be montmorillonite, Laponite, bentonite, or a combination of montmorillonite and Laponite.

For example, a thixotropic aqueous mixture of the invention may comprise about 1.3 wt. % smectite clay, about 2.0 wt. % lecithin, about 2.0 wt. % PVOH, and about 0.25 wt. % sodium citrate (e.g., about 0.6 wt. % laponite and 0.7 wt. % montmorillonite). A thixotropic aqueous mixture of the invention may alternatively comprise about 1.6 wt. % smectite clay, about 3.0 wt. % lecithin, about 2.5 wt. % PVOH, and about 0.20 wt. % sodium citrate (e.g., about 0.8 wt. % laponite and 0.8 wt. % montmorillonite). Further alternative thixotropic aqueous mixtures of the invention comprise about 1.1 wt. % Laponite, about 2.3 wt. % lecithin, about 2.1 wt. % PVOH, and about 0.2 wt. % sodium citrate. Yet further alternative thixotropic aqueous mixtures of the invention comprise about 1.0 wt. % bentonite, about 1.9 wt. % lecithin, about 1.5 wt. % PVOH, and about 0.2 wt. % sodium citrate.

In some embodiments, the ratio of the PVOH to smectite clay in a thixotropic aqueous mixture of the invention is between 1.25:1 and 2.5:1 (w/w), optionally wherein the ratio of the PVOH to the smectite clay is between 1.5:1 and 2:1 (w/w). In some embodiments, the ratio of the PVOH to lecithin in a thixotropic aqueous mixture of the invention is between 0.7:1 and 1.1:1 (w/w), optionally wherein the ratio of the PVOH to lecithin is between 0.8:1 and 1:1 (w/w).

In other embodiments, the water-soluble polymer is a natural water-soluble polymer. The term “natural” or “naturally-occurring”, as used in this context, refers to a water-soluble polymer that occurs in nature, or is derived from nature, and is not made or caused by humankind. This term does not require the polymer to be “obtained directly from nature”. A “natural” or “naturally-occurring” water-soluble may be nature-identical but this is not essential. Examples of naturally-occurring water-soluble polymers useful in the invention include polysaccharides.

In some embodiments, the thixotropic aqueous mixture of the invention comprises a polysaccharide. For example, a thixotropic aqueous mixture of the invention may comprise: a) smectite clay; b) lecithin; and c) a polysaccharide. In some embodiments, a thixotropic aqueous mixture of the invention may comprise: a) smectite clay; b) lecithin; c) a polysaccharide; and d) an antioxidant, optionally sodium citrate.

Examples of polysaccharides suitable for inclusion in a thixotropic aqueous mixture of the invention include xanthan gum, gum Arabic, pullulan, pectin, and carboxymethylcellulose. Particularly good results have been achieved using xanthan gum or gum Arabic. Thus, in some embodiments, the thixotropic aqueous mixture of the invention comprises xanthan gum or gum Arabic. For example, a thixotropic aqueous mixture of the invention may comprise: a) smectite clay; b) lecithin; and c) xanthan gum or gum Arabic. In some embodiments, a thixotropic aqueous mixture of the invention may comprise: a) smectite clay; b) lecithin; c) xanthan gum or gum Arabic; and d) an antioxidant, optionally sodium citrate. In any of these embodiments, the smectite clay may be, for example, montmorillonite, Laponite, bentonite, or a combination of montmorillonite and Laponite. For example, a thixotropic aqueous mixture of the invention may comprise a) montmorillonite; b) lecithin; c) xanthan gum or gum Arabic; and d) sodium citrate; or thixotropic aqueous mixture of the invention may comprise a) Laponite; b) lecithin; c) xanthan gum or gum Arabic; and d) sodium citrate.

It is contemplated that a polysaccharide is present in any of the thixotropic aqueous mixtures of the invention in an amount from 0.1 to 6.5 wt. %; optionally from 0.2 to 2.0 wt. %; optionally from 0.2 to 1.5 wt. %. For example, it is contemplated that xanthan gum is present in the mixture in an amount from 0.2 to 0.8 wt. %; optionally from 0.3 to 0.5 wt. %. In other embodiments, gum Arabic is present in the mixture in an amount from 0.2 to 4.0 wt. %, optionally from 0.5 to 2.0 wt. %.

In some embodiments, a thixotropic aqueous mixture of the invention comprises: a) smectite clay in an amount from 0.5 to 6.5 wt. %, such as from 1.0 to 5.0 wt. %, such as from 1.0 to 1.5 wt. %; b) a glycerophospholipid in an amount from 0.5 to 4.0 wt. %, such as 1.5 to 3.5 wt. %, such as 1.5 to 2.5 wt. %, such as about 2 wt. %; and c) a polysaccharide in an amount from 0.1 to 6.5 wt. %; such as 0.2 to 2.0 wt. %; such as 0.2 to 1.5 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; and c) a polysaccharide in an amount from 0.1 to 6.5 wt. %; such as 0.2 to 2.0 wt. %; such as 0.2 to 1.5 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; c) a polysaccharide in an amount from 0.1 to 6.5 wt. %; such as 0.2 to 2.0 wt. %; such as 0.2 to 1.5 wt. %; and d) an antioxidant, optionally sodium citrate, in an amount from 0.05 to 0.5 wt. %, such as 0.1 to 0.3 wt. %., such as about 0.2 or 0.25 wt. %. In some embodiments, a thixotropic aqueous mixture of the invention comprises: a) smectite clay in an amount from 1.0 to 1.5 wt. %; and b) lecithin in an amount of about 2 wt. %; c) a polysaccharide in an amount from 0.1 to 6.5 wt. %; such as 0.2 to 2.0 wt. %; such as 0.2 to 1.5 wt. %; and sodium citrate in an amount of about 0.2 or 0.25 wt. %. In any of these embodiments, the smectite clay may be montmorillonite, Laponite, or a combination of montmorillonite and Laponite.

Accordingly, it is contemplated that a thixotropic aqueous mixture of the invention comprises: a) smectite clay in an amount from 0.5 to 6.5 wt. %, such as from 1.0 to 5.0 wt. %, such as from 1.0 to 1.5 wt. %; b) a glycerophospholipid in an amount from 0.5 to 4.0 wt. %, such as 1.5 to 3.5 wt. %, such as 1.5 to 2.5 wt. %, such as about 2 wt. %; and c) xanthan gum in an amount from 0.2 to 0.8 wt. %; such as 0.3 to 0.5 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; and c) xanthan gum in an amount from 0.2 to 0.8 wt. %; such as 0.3 to 0.5 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; c) xanthan gum in an amount from 0.2 to 0.8 wt. %; such as 0.3 to 0.5 wt. %; and d) an antioxidant, optionally sodium citrate, in an amount from 0.05 to 0.5 wt. %, such as 0.1 to 0.3 wt. %., such as about 0.2 or 0.25 wt. %. In some embodiments, a thixotropic aqueous mixture of the invention comprises: a) smectite clay in an amount from 1.0 to 1.5 wt. %; and b) lecithin in an amount of about 2 wt. %; c) xanthan gum in an amount from 0.3 to 0.5 wt. %; and sodium citrate in an amount of about 0.2 or 0.25 wt. %. In any of these embodiments, the smectite clay may be montmorillonite, Laponite, or a combination of montmorillonite and Laponite.

It is also contemplated that a thixotropic aqueous mixture of the invention comprises: a) smectite clay in an amount from 0.5 to 6.5 wt. %, such as from 1.0 to 5.0 wt. %, such as from 1.0 to 1.5 wt. %; b) a glycerophospholipid in an amount from 0.5 to 4.0 wt. %, such as 1.5 to 3.5 wt. %, such as 1.5 to 2.5 wt. %, such as about 2 wt. %; and c) gum Arabic in an amount from 0.2 to 4.0 wt. %, such as 0.5 to 2.0 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; and c) gum Arabic in an amount from 0.2 to 4.0 wt. %, such as 0.5 to 2.0 wt. %. For example, a thixotropic aqueous mixture of the invention may comprise: a) smectite clay in an amount from 0.5 to 6.5 wt. %, such as from 1.0 to 5.0 wt. %, such as from 1.0 to 1.5 wt. %; b) lecithin in an amount from 0.5 to 4.0 wt. %, such as 1.5 to 3.5 wt. %, such as 1.5 to 2.5 wt. %, such as about 2 wt. %; c) gum Arabic in an amount from 0.2 to 4.0 wt. %, such as 0.5 to 2.0 wt. %; and d) an antioxidant, optionally sodium citrate, in an amount from 0.05 to 0.5 wt. %, such as 0.1 to 0.3 wt. %., such as about 0.2 or 0.25 wt. %. In some embodiments, a thixotropic aqueous mixture of the invention comprises: a) smectite clay in an amount from 1.0 to 1.5 wt. %; and b) lecithin in an amount of about 2 wt. %; c) gum Arabic in an amount from 0.5 to 2.0 wt. %; and sodium citrate in an amount of about 0.2 wt. %. In any of these embodiments, the smectite clay may be montmorillonite, Laponite, or a combination of montmorillonite and Laponite.

In some embodiments, the ratio of the polysaccharide to smectite clay in a thixotropic aqueous mixture of the invention is from 5:1 to 1:5 (w/w), optionally from 1:2 to 1:4 (w/w). For example, the ratio of xanthan gum to smectite clay may be from 1:2 to 1:5, such as from 1:2.5 to 1:4 (w/w); or the ratio of gum Arabic to smectite clay may be from 5:1 to 1:4; optionally from 1:2 to 1:3.5, optionally about 1:2.5 (w/w).

In some embodiments, the ratio of the polysaccharide to glycerophospholipid (e.g., lecithin) in a thixotropic aqueous mixture of the invention is from 3:1 to 1:10 (w/w), optionally from 1.5:1 to 1:5 (w/w). For example, it is contemplated that the ratio of xanthan gum to lecithin is from 1:1 to 1:10, such as from 1:3 to 1:5 (w/w), such as about 1:5 (w/w); or that the ratio of gum Arabic to lecithin is from 3:1 to 1:3, such as from 1.5:1 to 1:2.5, such as from 1:1.5 to 1.2.5 (w/w) or from 1:1.5 to 1.2.0 (w/w).

Food grade smectite clay, glycerophospholipid (e.g., lecithin), PVOH, and/or polysaccharide (e.g., xanthan gum or gum Arabic) are particularly suitable for use in the present invention. The term “food grade”, as used herein, refers to a substance that is safe for human or animal consumption and that is permitted to come into direct contact with food meant for human or animal consumption.

The thixotropic aqueous mixture of the invention comprises water. The smectite clay and other solids are dispersed in the water to form a colloidal dispersion. The water may further act as a solvent for any water-soluble polymer in the mixture. In some embodiments, the thixotropic aqueous mixture comprises water and a further solvent (optionally a food grade solvent), such as ethanol. If a volatile solvent such as ethanol is present, it makes up no more than 25% of the total solvent in the mixture. In some embodiments, the thixotropic aqueous mixture of the invention is an aqueous colloidal dispersion comprising 2%-10% solids, optionally 3%-6% solids, optionally 3.5-5.5% solids. In an aqueous colloidal dispersion, the smectite is not dissolved in solution but is dispersed such that individual clay platelets stay in colloidal dispersion. The solids content of an aqueous colloidal dispersion is measured by drying out a known volume of dispersion and weighing the dry solids.

The thixotropic aqueous mixture is typically edible, meaning that it is safe for human or animal consumption. In some embodiments, the thixotropic aqueous mixture does not negatively modify the produce to which it is applied. For example, if the produce is organic, the thixotropic aqueous mixture is also organic. The term “organic”, as used herein, refers to components that, once applied to produce, would not change the organic status of produce. Thus, these components meet the standards set for organically produced agricultural products, such as the regulations for an “organic” claim set by the national organic program (NOP) of the U.S. Department of Agriculture (USDA). In some embodiments, an organic thixotropic aqueous mixture does not contain any inorganic components, where the term “inorganic”, as used herein, refers to components that, once applied to produce, would change the organic status of produce.

The invention also provides methods for making a thixotropic aqueous mixture of the invention, and mixtures made by these methods. The methods for making a thixotropic aqueous mixture generally comprise at least one mixing step performed under high shear.

Therefore, in a second aspect, the invention provides a method of making a thixotropic aqueous mixture of the invention. The method comprises mixing at least one smectite clay and a glycerophospholipid (e.g., lecithin), and optionally one or more additional components as described herein, with water. At least one mixing step is performed under high shear. Thereby, a thixotropic aqueous mixture of the invention is formed.

In the methods of the invention, the smectite clay and other solids are dispersed in the water. The water may also act as a solvent for a water-soluble polymer, if present. In some embodiments, the method uses water and a further solvent (optionally a food grade solvent), optionally a volatile solvent, such as ethanol. If a volatile solvent such as ethanol is present, it makes up no more than 25% of the total solvent used in the method.

The methods of the invention for making a thixotropic aqueous mixture involve at least one step performed under high shear. Any of the methods or method steps described herein that involve high shear mixing may be carried out using any known high shear mixer, such as a vane mixer, Cowles dissolver, or colloid mill. High shear mixing requires equipment with high RPM and horsepower that ensure the dispersion blade can reach top speeds of between 2,500 to 5,000 feet per minute. The high shear mixing process may take 1-2 hours. For mixing of smaller batches of composition, a high shear blender may be used. High shear methods are advantageous because they achieve rapid dispersion of the smectite clay in the water, and/or rapid mixing of smectite clay with one or more other components of the mixture, to form a thixotropic aqueous mixture that ensures an even dispersal of smectite clay particles (platelets). When using standard mixing methods that do not involve high shear (such as a tank with paddle mixer), mixing of smectite clay and other components in water will never fully disperse the smectite clay to form an evenly dispersed mixture. This is because the smectite clay platelets are held together in stacks by many weak bonds, such as hydrogen bonds and ion dipole interactions, which collectively amount to a large cohesive force. Standard mixing is not sufficient to overcome this cohesive energy. When using a method that involves high shear, the increased energy and substantial force imposed by the high shear is sufficient to break the forces that holds the clay platelets together. Thus, a high shear method of making the thixotropic aqueous mixture of the invention is highly efficient.

In some embodiments, the smectite clay and the glycerophospholipid (e.g., lecithin) are combined in powder form, and then this smectite clay and glycerophospholipid “pre-mix” is combined with (e.g., added to) water and mixed under high shear mixing conditions to disperse the smectite clay and glycerophospholipid in the water.

Alternatively, it is contemplated that the smectite clay and the glycerophospholipid (e.g., lecithin) are added separately to water and mixed under high shear. In these embodiments, adding components “separately” encompasses adding the components to the water simultaneously, or adding each component sequentially. Thus, in some embodiments, the method comprises adding at least one smectite clay to water, followed by high shear mixing to form an aqueous colloidal dispersion of smectite clay in water, and then adding the glycerophospholipid (e.g., lecithin) to the aqueous colloidal dispersion, optionally followed by further high shear mixing. In other embodiments, the method comprises adding the smectite clay and the glycerophospholipid (e.g., lecithin) to water, following by mixing under high shear.

In some embodiments, the method of the invention of making a thixotropic aqueous mixture comprises mixing: a) at least one smectite clay; b) a glycerophospholipid (e.g., lecithin), and c) an antioxidant (e.g., sodium citrate), with water, to form the thixotropic aqueous mixture. In some embodiments, the method comprises mixing: a) at least one smectite clay; b) lecithin, and c) sodium citrate, with water, to form the thixotropic aqueous mixture. At least one mixing step of the method is performed under high shear.

It is contemplated that the smectite clay, the glycerophospholipid (e.g., lecithin), and the antioxidant (e.g., sodium citrate) may be mixed together in powder form, and then this smectite clay, glycerophospholipid, and antioxidant “pre-mix” is combined with (e.g., added to) water and mixed under high shear mixing conditions. Alternatively, it is contemplated that the smectite clay, the glycerophospholipid (e.g., lecithin), and the antioxidant (e.g., sodium citrate) are added separately to water and mixed under high shear. In these embodiments, adding components “separately” encompasses adding the components to the water simultaneously, adding two components simultaneously with the other component added sequentially, or adding each component sequentially. Thus, in some embodiments, the method comprises adding smectite clay to water, followed by high shear mixing to form an aqueous colloidal dispersion of smectite clay in water, and then adding the glycerophospholipid (e.g., lecithin) and the antioxidant (e.g., sodium citrate) to the aqueous colloidal dispersion, optionally followed by further high shear mixing. In other embodiments, the method comprises adding smectite clay and the glycerophospholipid (e.g., lecithin) to water, followed by mixing under high shear, and then adding the antioxidant (e.g., sodium citrate) to the mixture, optionally followed by further high shear mixing. In further embodiments, the method comprises adding smectite clay to water, followed by high shear mixing to form an aqueous colloidal dispersion of smectite clay in water, and then adding the glycerophospholipid (e.g., lecithin) to the aqueous colloidal dispersion, optionally followed by further high shear mixing, and then adding the antioxidant (e.g., sodium citrate) to the mixture, optionally followed by further high shear mixing.

In some embodiments, the method of the invention of making a thixotropic aqueous mixture comprises mixing: a) at least one smectite clay; b) a glycerophospholipid (e.g., lecithin), and c) a water-soluble polymer (e.g., PVOH or a polysaccharide), with water, to form the thixotropic aqueous mixture. In some embodiments, the method comprises mixing: a) at least one smectite clay; b) lecithin, and c) PVOH or a polysaccharide (e.g., xanthan gum or gum Arabic), with water, to form the thixotropic aqueous mixture. At least one mixing step of the method is performed under high shear.

It is contemplated that the smectite clay, the glycerophospholipid (e.g., lecithin), and the water-soluble polymer (e.g., PVOH or a polysaccharide) may be mixed together in powder form, and then this smectite clay, glycerophospholipid, and polymer “pre-mix” is combined with (e.g., added to) water and mixed under high shear mixing conditions. Alternatively, it is contemplated that the smectite clay, the glycerophospholipid (e.g., lecithin), and the water-soluble polymer (e.g., PVOH or a polysaccharide) are added separately to water and mixed under high shear. In these embodiments, adding components “separately” encompasses adding the components to the water simultaneously, adding two components simultaneously with the other component added sequentially, or adding each component sequentially. Thus, in some embodiments, the method comprises adding smectite clay to water, followed by high shear mixing to form an aqueous colloidal dispersion of smectite clay in water, and then adding the glycerophospholipid (e.g., lecithin) and the water-soluble polymer (e.g., PVOH or a polysaccharide) to the aqueous colloidal dispersion, optionally followed by further high shear mixing. In other embodiments, the method comprises adding smectite clay and the glycerophospholipid (e.g., lecithin) to water, followed by mixing under high shear, and then adding water-soluble polymer (e.g., PVOH or a polysaccharide) to the mixture, optionally followed by further high shear mixing. In further embodiments, the method comprises adding smectite clay to water, followed by high shear mixing to form an aqueous colloidal dispersion of smectite clay in water, and then adding the glycerophospholipid (e.g., lecithin) to the aqueous colloidal dispersion, optionally followed by further high shear mixing, and then adding water-soluble polymer (e.g., PVOH or a polysaccharide) to the mixture, optionally followed by further high shear mixing.

In some embodiments, the method of the invention of making a thixotropic aqueous mixture comprises mixing: a) at least one smectite clay; b) a glycerophospholipid (e.g., lecithin); c) a water-soluble polymer (e.g., PVOH or a polysaccharide); and d) an antioxidant (e.g., sodium citrate) with water, to form the thixotropic aqueous mixture. In some embodiments, the method comprises mixing: a) at least one smectite clay; b) lecithin; c) PVOH; or a polysaccharide (e.g., xanthan gum or gum Arabic), and d) sodium citrate, with water, to form the thixotropic aqueous mixture. At least one mixing step of the method is performed under high shear.

It is contemplated that the smectite clay, the glycerophospholipid (e.g., lecithin), the water-soluble polymer (e.g., PVOH or a polysaccharide), and the antioxidant (e.g., sodium citrate) may be mixed together in powder form, and then this smectite clay, glycerophospholipid, polymer, and antioxidant “pre-mix” is combined with (e.g., added to) water and mixed under high shear mixing conditions. Alternatively, it is contemplated that the smectite clay, the glycerophospholipid (e.g., lecithin), the water-soluble polymer (e.g., PVOH or a polysaccharide), and the antioxidant (e.g., sodium citrate) are added separately to water and mixed under high shear. In these embodiments, adding components “separately” encompasses adding the components to the water simultaneously, adding two components simultaneously with the other component added sequentially, or adding each component sequentially. Thus, in some embodiments, the method comprises adding smectite clay to water, followed by high shear mixing to form an aqueous colloidal dispersion of smectite clay in water, and then adding the glycerophospholipid (e.g., lecithin), the water-soluble polymer (e.g., PVOH or a polysaccharide), and the antioxidant (e.g., sodium citrate) to the aqueous colloidal dispersion, optionally followed by further high shear mixing. In other embodiments, the method comprises adding smectite clay and the glycerophospholipid (e.g., lecithin) to water, followed by mixing under high shear, and then adding water-soluble polymer (e.g., PVOH or a polysaccharide) and the antioxidant (e.g., sodium citrate) to the mixture, optionally followed by further high shear mixing. In further embodiments, the method comprises adding smectite clay to water, followed by high shear mixing to form an aqueous colloidal dispersion of smectite clay in water, and then adding the glycerophospholipid (e.g., lecithin) to the aqueous colloidal dispersion, optionally followed by further high shear mixing, then adding water-soluble polymer (e.g., PVOH or a polysaccharide) to the mixture, optionally followed by further high shear mixing, and then adding the antioxidant (e.g., sodium citrate) to the mixture, optionally followed by further high shear mixing.

The description and definitions provided herein in the context of the thixotropic aqueous mixture of the invention also apply to methods of the invention for making a thixotropic aqueous mixture. In particular, the smectite clay and glycerophospholipid used in the method can each be as described in the context of the thixotropic aqueous mixtures of the invention, and can each be used in the amounts and/or ratios described in the context of the thixotropic aqueous mixtures of the invention. In embodiments of the methods that use an antioxidant and/or a water-soluble polymer, these components can each be as described in the context of the thixotropic aqueous mixtures of the invention, and can each be used in the amounts and/or ratios described in the context of the thixotropic aqueous mixtures of the invention.

The invention also provides a thixotropic aqueous mixture prepared by any of the methods of the invention. For example, a thixotropic aqueous mixture made by any of the methods of the invention may comprise a smectite clay (e.g., montmorillonite, Laponite, bentonite, or a combination of montmorillonite and Laponite) and lecithin. In some embodiments, a thixotropic aqueous mixture prepared by any of the methods of the invention comprises a smectite clay, lecithin, and sodium citrate. In some embodiments, a thixotropic aqueous mixture prepared by any of the methods of the invention comprises a smectite clay, lecithin, PVOH, and sodium citrate; or comprises a smectite clay, lecithin, a polysaccharide (e.g., xanthan gum or gum Arabic), and sodium citrate. The thixotropic aqueous mixture made by any of the methods of the invention may be edible, and may optionally be organic. These terms have the meanings defined herein.

It is contemplated that any of the methods of the invention for making a thixotropic aqueous mixture of the invention may further comprise applying the thixotropic aqueous mixture to the surface of produce. Thus, the invention provides a method, comprising: i) making a thixotropic aqueous mixture using a high shear method of the invention; and ii) applying said thixotropic aqueous mixture to the surface of produce. The thixotropic aqueous mixture forms a coating on the surface of the produce to which it is applied. The coating confers one or more beneficial barrier properties to the produce surface as defined herein. The coating may protect the produce from dehydration and/or oxidation; and/or the coating may delay ripening of the produce, as compared to uncoated produce. Thereby, the coating may enhance the shelf life of the produce, as compared to the same produce lacking the coating of the invention.

In a third aspect, the invention provides methods comprising applying a thixotropic aqueous mixture of the invention to the surface of produce in order to achieve one or more beneficial properties. In some embodiments, the invention provides a method of improving one or more barrier properties (e.g., gas and/or moisture barrier properties) of the surface of produce, comprising applying a thixotropic aqueous mixture of the invention to the surface of the produce, whereby the one or more barrier properties of the surface is improved compared to the barrier property/ies of an uncoated produce surface. In some embodiments, the invention provides a method of protecting produce from dehydration and/or oxidation, comprising applying a thixotropic aqueous mixture of the invention to the surface of produce. In some embodiments, the invention provides a method of delaying ripening of produce, comprising applying a thixotropic aqueous mixture of the invention to the surface of produce, whereby ripening of the produce is delayed compared to ripening of uncoated produce. In some embodiments, the invention provides a method of extending the shelf life of produce, comprising applying a thixotropic aqueous mixture of the invention to the surface of produce, whereby the shelf life of the produce is extended compared to the shelf life of uncoated produce.

The term “produce”, as used herein, refers to farm-produced crops. In some embodiments, the produce is fruit. In some embodiments, the produce is climacteric fruit, such as pome fruit or avocados. In some embodiments, the produce is pome fruit (e.g., apples or pears), stone fruit (including avocados and cherries), citrus fruit (e.g., lemons or mandarins), or tomatoes. The invention is particularly applicable to pome fruits, more particularly apples, pears, and/or quince. In some embodiments, the produce is vegetable produce. For example, the vegetable produce may be cucumbers or mushrooms.

In all aspects of the invention, reference to a “surface” of produce, such as fruit or vegetables, refers to an outer surface of the produce, which may be referred to as the skin, rind, or peel depending on the type of produce. For example, in some embodiments, the invention is directed to thixotropic aqueous mixtures and methods for improving one or more barrier properties (e.g., gas and/or moisture barrier properties) of the skin of pome fruit, such as apples or pears, as compared to the same, uncoated, pome fruit. In some embodiments, the thixotropic aqueous mixtures and methods of the invention reduce the transfer of gases, including oxygen and carbon dioxide, through the skin of pome fruit, thereby reducing the respiration rate of the pome fruit, and slowing down the ripening effects of ethylene on the pome fruit. By reducing the transfer of atmospheric oxygen though the skin of the pome fruit, the thixotropic aqueous mixture and methods of the invention may protect the fruit against oxidation. Further, by reducing the loss of moisture, including water, though the skin of the pome fruit, the thixotropic aqueous mixture of the invention may protect the fruit against transpiration and/or dehydration. Any one of more of these barrier properties may contribute to improvements in shelf life and/or ready to eat window of the pome fruit.

The thixotropic aqueous mixture used in the methods of the invention can be any of the thixotropic aqueous mixtures of the invention described herein. In some embodiments, the thixotropic aqueous mixture used in the methods of the invention comprises at least one smectite clay (e.g., montmorillonite, Laponite, bentonite, or a combination of montmorillonite and Laponite) and lecithin. In some embodiments, a thixotropic aqueous mixture used in any of the methods of the invention comprises a smectite clay, lecithin, and sodium citrate. In some embodiments, a thixotropic aqueous mixture used in any of the methods of the invention comprises a smectite clay, lecithin, PVOH, and sodium citrate; or comprises a smectite clay, lecithin, a polysaccharide (e.g., xanthan gum or gum Arabic), and sodium citrate. The description and definitions provided herein in the context of the thixotropic aqueous mixture of the invention also apply to methods of the invention that make use of a thixotropic aqueous mixture. In particular, the smectite clay and glycerophospholipid components of a thixotropic aqueous mixture used in any of the methods of the invention can each be as described in the context of the thixotropic aqueous mixtures of the invention, and can each be used in the amounts and/or ratios described in the context of the thixotropic aqueous mixtures of the invention. In methods that use a thixotropic aqueous mixture comprising an antioxidant and/or a water-soluble polymer, these components can each be as described in the context of the thixotropic aqueous mixtures of the invention, and can each be used in the amounts and/or ratios described in the context of the thixotropic aqueous mixtures of the invention.

In some embodiments, the thixotropic aqueous mixture is applied to the produce pre-harvest, but in other embodiments the thixotropic aqueous mixture is applied post-harvest. The maximum effect on shelf life is seen when the thixotropic aqueous mixture is applied pre-harvest, but a substantial effect is also seen if produce is coated after storage.

It is contemplated that in the methods of the invention that involve application of thixotropic aqueous mixture to the surface of produce, the thixotropic aqueous mixture may be applied by any one or more means suitable for applying a thin, even coating of the mixture on the produce surface. For example, the thixotropic aqueous mixture may be applied to the produce surface by dipping the produce into the thixotropic aqueous mixture, and/or the thixotropic aqueous mixture may be sprayed and/or brushed onto the surface of the produce. In some embodiments, the thixotropic aqueous mixture is applied to the produce surface by spraying, optionally by a combination of spraying and brushing. In other embodiments, the thixotropic aqueous mixture is applied to the produce surface by a combination of dipping and brushing. In some embodiments, the application method involves high shear.

In some embodiments, therefore, the thixotropic aqueous mixture may be applied to the surface of produce using a dip tank, spray bar, or brush bed, or any combination thereof.

In some embodiments, the thixotropic aqueous mixture is applied using a dip tank. A dip tank is a piece of equipment capable of housing 5000 to 10000 liters of thixotropic aqueous mixture of the invention, which facilitates the submersion of produce in order to coat the produce surface. For example, the produce is dipped into the thixotropic aqueous mixture once with a residence time of 2 to 5 minutes of immersion. A dip tank can be used apply a thixotropic aqueous mixture of the invention to produce at a rate of about 500 pounds of produce per liter of mixture. After application of the mixture using a dip tank, the produce may be placed onto a draining belt to remove excess mixture.

It is contemplated that the thixotropic aqueous mixture may be applied to the surface of produce using a combination of a dip tank and brush bed. Brush beds normally have 6 to 12 brushes that are rolling, and act to both convey and brush the produce. Following application of the thixotropic aqueous mixture to the surface of the produce, these brushes evenly and efficiently coat the produce with the thixotropic aqueous mixture of the invention. The use of a brush bed is particularly advantageous because it ensures that there is an even coating of thixotropic aqueous mixture on the produce and avoids using excess mixture.

In some embodiments, the thixotropic aqueous mixture is applied using a spray bar, optionally using a combination spray bar and brush bed. A spray bar is a piece of equipment comprising a pump and at least one nozzle for spraying thixotropic aqueous mixture onto produce. In the application stage, the high shear imparted by the pump and spray nozzles of the spray bar lowers the viscosity of the thixotropic aqueous mixture and lessens the resistance to flow when applying the thixotropic aqueous mixture to the surface of the produce. A spray bar can be used apply the thixotropic aqueous mixture to produce at a spray rate of at least 1000 pounds of produce per liter of thixotropic aqueous mixture; such as in the range of 1000 to 7000 pounds of produce per liter of mixture, such as 3000 to 7000 pounds of produce per liter of mixture. Once the spray of the thixotropic aqueous mixture impinges upon the surface of the produce (i.e., the thixotropic aqueous mixture meets the surface of the produce), the viscosity recovers and forms a fairly uniform coating on the produce. This advantageous feature, observed during the application of the thixotropic aqueous mixture of the invention, is due to the non-Newtonian fluid dynamics of the thixotropic mixture. In some embodiments, the thixotropic aqueous mixture is sprayed onto the surface of the produce using the spray bar and then a brush bed is used as described above to increase the comprehensiveness of the coating.

Spraying may optionally be performed after dipping the produce into the thixotropic aqueous mixture in a dip tank and before the optional brush bed. For example, after the produce exits the dip tank and draining belt, further thixotropic aqueous mixture may be sprayed onto the produce using a spray bar located after the draining belt and before the optional brush bed.

Prior to applying the thixotropic mixture, the produce may be washed in a dunk tank. A dunk tank is typically a 10000-liter tank used to introduce the produce to the pack line and to wash the produce and remove any debris, such as leaf and twigs. The use of a dunk tank is advantageous because it minimizes any damage which may be inflicted on the produce during these processes. The dunk tank and/or dip tank may contain a mild disinfectant, such as paracidic acid.

The methods may further comprise drying the thixotropic aqueous mixture following application to the surface of the produce (e.g., by applying heat), but more typically the mixture is left to dry naturally on the surface of the produce under ambient conditions.

The coatings formed in use of the thixotropic aqueous mixture of the invention are generally transparent. The term “transparent”, as used herein, refers to a coating that allows light to pass through. As such, the coating film on the surface may be undetectable by the human eye, other than an optional sheen that may differentiate a coated surface from an uncoated surface. Therefore, the transparent coating allows the surface of the produce to be distinctly seen through the coating. The skilled person can determine whether a coating is transparent by eye or using methods known in the art.

The methods of the invention for coating the surface of produce with a thixotropic aqueous mixture of the invention are demonstrated to improve one or more barrier properties of the produce surface, as compared to a surface of the produce that is not coated with a thixotropic aqueous mixture of the invention (i.e., an “uncoated” surface/“uncoated produce”, which may have a different (e.g., wax-based) coating, or may have no coating of any kind). For example, it is contemplated that the methods of the invention create a barrier between the produce surface and the external environment that reduces the transfer of gas and/or moisture though the surface, as compared to an uncoated surface—i.e., the methods apply a layer of thixotropic aqueous mixture on the produce surface that acts as a gas and/or moisture (e.g., water vapor) barrier. Thus, applying the thixotropic aqueous mixture of the invention to the produce surface may reduce the transfer of gases, including oxygen and carbon dioxide, through the produce surface, and thereby reduce the produce respiration rate, slow down the effects of ethylene on produce ripening, and/or protect the produce against oxidation. Further, applying the thixotropic aqueous mixture of the invention to the produce surface may reduce the loss of moisture, including water, though the produce surface, thereby protecting the produce from dehydration. Any one of more of these barrier properties may contribute to improvements in shelf life and/or ready to eat window of produce.

In some embodiments, the thixotropic aqueous mixtures and methods of the invention are for protecting produce from dehydration. Dehydration of produce is accelerated in drier environmental conditions and with exposure to air/oxygen. For example, water is lost from produce, such as fruit (e.g., pome fruit) and vegetables, during storage. The thixotropic aqueous mixtures and related methods of the invention are useful for reducing moisture loss from produce by reducing the moisture vapor transmission rate across the surface of the produce to which the thixotropic aqueous mixture is applied. Protecting produce “from dehydration”, as used herein, refers to protecting against moisture loss (such as loss of water) through a surface of the produce. In these embodiments, “protecting” from dehydration encompasses reducing or even preventing dehydration. A reduction in dehydration may be defined in comparison to the dehydration of the same produce that is not coated with a thixotropic aqueous mixture of the invention (i.e., the same produce without any coating composition, or the same produce coated with a conventional composition known in the art). Methods are known in the art for observing and measuring dehydration of produce. For example, dehydration may be measured by weighing the produce at time intervals, where a loss of weight as compared to an earlier weight measurement corresponds to loss of moisture.

In some embodiments, pome fruit coated in a thixotropic aqueous mixture of the invention lose at least 25% less weight (such as at least 30% less weight, or at least 40% or 45% less weight) during storage for 9 days at ambient temperature, as compared to the same produce that is uncoated (control). When monitored for longer periods, in some embodiments, pome fruit lose at least 10% less weight (such as at least 20% less weight, or at least 25% less weight) during storage for 24 days at ambient temperature, as compared to the same produce that is uncoated (control). For example, it is demonstrated herein that pears coated in any of 8 different thixotropic aqueous mixtures of the invention lost on average 29% to 49% less weight (i.e., had on average 29-49% improved water retention) during storage for 9 days at ambient temperature, as compared to uncoated pears. Further, it is demonstrated herein that apples coated in any of 13 different thixotropic aqueous mixtures of the invention lost on average 11% to 27% less weight (i.e., had on average 11-27% improved water retention) during storage for 24 days at ambient temperature, as compared to uncoated apples. Therefore, the thixotropic aqueous mixtures and methods of the invention provide substantial protection against dehydration of pome fruit, such as apples or pears.

In some embodiments, citrus fruit coated in a thixotropic aqueous mixture of the invention lose at least 10% less weight (such as at least 20% less weight, or at least 25% less weight) during storage for 3 days at ambient temperature, as compared to the same produce that is uncoated (control). When monitored for longer periods, in some embodiments, citrus fruit lose at least 5% less weight (such as at least 10% less weight, or at least 15% less weight) during storage for 7 days at ambient temperature, as compared to the same produce that is uncoated (control). For example, it is demonstrated herein that lemons coated in various different thixotropic aqueous mixtures of the invention lost on average 24% to 28% less weight (i.e., had on average 24-28% improved water retention) during storage for 3 days at ambient temperature, and lost on average 9% to 16% less weight (i.e., had on average 9-16% improved water retention) during storage for 7 days at ambient temperature, as compared to uncoated lemons. Further, it is demonstrated herein that mandarins coated in various different thixotropic aqueous mixtures of the invention lost on average 14% to 22% less weight (i.e., had on average 14-22% improved water retention) during storage for 3 days at ambient temperature, and lost on average 14% to 18% less weight (i.e., had on average 14-18% improved water retention) during storage for 7 days at ambient temperature, as compared to uncoated mandarins. Therefore, the thixotropic aqueous mixtures and methods of the invention provide substantial protection against dehydration of citrus fruit, such as lemons or mandarins.

In some embodiments, the thixotropic aqueous mixtures and methods of the invention are for protecting produce from oxidation. Oxidation of produce, such as fruits (e.g., pome fruit) and vegetables, causes browning and softening of the produce. The thixotropic aqueous mixture and related methods of the invention are useful for protecting produce from oxidation by reducing the oxygen transmission rate across a surface of the produce to which the thixotropic aqueous mixture is applied. Protecting produce “from oxidation”, as used herein, refers to protecting against oxidation of the produce or its surface. In these embodiments, “protecting” from oxidation encompasses reducing or even preventing oxidation. A reduction in oxidation may be defined in comparison to the oxidation of the same produce that is not coated with a thixotropic aqueous mixture of the invention (i.e., the same produce without any coating composition, or the same produce coated with a conventional composition known in the art). Methods are known in the art for observing and measuring oxidation of produce. For example, oxidation of produce (e.g., browning and/or softening of produce such as fruit, especially pome fruit) is typically observed and measured by eye.

In some embodiments, the thixotropic aqueous mixtures and methods of the invention are for delaying ripening of produce. Methods are known in the art for observing and measuring when produce becomes ripe and over-ripe. For example, ripeness of fruit and vegetables may be observed by eye or by touch. In pears, a color transition from green to yellow (observed by eye) is an indicator of over-ripeness. Ripeness may also be determined by measuring the resistance of produce to pressure (i.e., by determining firmness). It is contemplated that the time for produce coated with a thixotropic aqueous mixture of the invention to reach ripeness may be delayed by at least 10%, 20%, or 30% as compared to control, uncoated produce. For example, it is demonstrated herein that a thixotropic aqueous mixture of the invention delays the time for pears to ripen by about 30% as compared to a control composition lacking lecithin and having a higher solids content. Pears coated with a thixotropic aqueous mixture of the invention retained an appealing green color and showed less signs of damage on the skin, after storage for 7 days, as compared to uncoated controls.

The shelf life of fresh produce may be defined as the length of time that the produce may be stored without becoming unfit for use, consumption, or sale. During the shelf life of produce, the defined quality of a specified proportion of the produce remains acceptable under expected (or specified) conditions. Dehydration and/or oxidation of produce may reduce its shelf-life. Therefore, protecting the produce against dehydration and/or oxidation is useful for maintaining the produce's expected shelf life or improving the produce's shelf-life. An “improvement” in shelf life may be an extension of the length of time that the produce may be stored without becoming unfit for use, consumption, or sale. The improvement in shelf life is achieved in comparison to the shelf life of the same produce that is not coated with a thixotropic aqueous mixture of the invention (i.e., the same produce without any coating composition, or the same produce coated with a conventional composition known in the art). An extension of produce shelf life may be measured in days, or as a % increase in shelf-life, as compared to the control produce. For example, it is demonstrated herein that the shelf life of pome fruit (e.g., pears) coated with a thixotropic aqueous mixture of the invention may be extended by at least 4, 6, or 8 days as compared to control, uncoated produce.

In a fourth aspect, the invention provides uses of any of the thixotropic aqueous mixtures of the invention. In particular, the invention provides the use of a thixotropic aqueous mixture of the invention to achieve one or more beneficial properties. In some embodiments, the invention provides the use of a thixotropic aqueous mixture of the invention for improving one or more barrier properties (e.g., gas and/or moisture barrier properties) of the surface of produce, compared to the barrier property/ies of uncoated produce. In some embodiments, the invention provides the use of a thixotropic aqueous mixture of the invention for protecting produce from dehydration and/or oxidation. In some embodiments, the invention provides the use of a thixotropic aqueous mixture of the invention for delaying ripening of produce. In some embodiments, the invention provides the use of a thixotropic aqueous mixture of the invention for extending the shelf life of produce. Protecting produce from dehydration and/or oxidation, and methods for determining and measuring dehydration and/or oxidation are defined herein. Likewise, “ripening” and “shelf life”, and methods for determining ripening and shelf life are defined herein. The term “produce” is also defined herein. In any of these uses of the invention, the thixotropic aqueous mixture can be any of the thixotropic aqueous mixtures of the invention described herein.

The thixotropic aqueous mixture for use in the invention can be any of the thixotropic aqueous mixtures of the invention described herein. In some embodiments, the thixotropic aqueous mixture used in the invention comprises at least one smectite clay (e.g., montmorillonite, Laponite, bentonite, or a combination of montmorillonite and Laponite) and lecithin. In some embodiments, a thixotropic aqueous mixture used in the invention comprises a smectite clay, lecithin, and sodium citrate. In some embodiments, a thixotropic aqueous mixture used in the invention comprises a smectite clay, lecithin, PVOH, and sodium citrate; or comprises a smectite clay, lecithin, a polysaccharide (e.g., xanthan gum or gum Arabic), and sodium citrate. The description and definitions provided herein in the context of the thixotropic aqueous mixture of the invention also apply to uses of a thixotropic aqueous mixture. In particular, the smectite clay and glycerophospholipid components of a thixotropic aqueous mixture used in the invention can each be as described in the context of the thixotropic aqueous mixtures of the invention, and can each be used in the amounts and/or ratios described in the context of the thixotropic aqueous mixtures of the invention. In any use of a thixotropic aqueous mixture comprising an antioxidant and/or a water-soluble polymer, these components can each be as described in the context of the thixotropic aqueous mixtures of the invention, and can each be used in the amounts and/or ratios described in the context of the thixotropic aqueous mixtures of the invention.

### Further Compositions and Methods of the Invention

The invention also provides a thixotropic aqueous mixture comprising: a) smectite clay; b) xanthan gum; and c) an antioxidant. This mixture is for (suitable and effective for) protecting produce from dehydration and/or oxidation, and/or for delaying ripening of produce, and/or for extending the shelf life of produce.

Any one or more smectite clay can be used in this aspect of the invention. In some embodiments, the smectite clay is montmorillonite, or montmorillonite and hectorite. It is contemplated that the smectite clay is present in the thixotropic aqueous mixture in an amount from, for example, 0.5 to 4 wt. %, optionally from 1.0 to 4 wt. %, optionally from 1.0 to 3.5 wt. %. In some embodiments, the thixotropic aqueous mixture comprises montmorillonite in an amount from 0.5 to 2.5 wt. %, such as 1.0 to 2.0 wt. %, such as from 1.0 to 1.5 wt. %. In some embodiments, the thixotropic aqueous mixture further comprises hectorite in an amount from 1.0 to 2.5 wt. %, such as from 1.5 to 2.0 wt. %. Thus, in some embodiments, the thixotropic aqueous mixture comprises: a) montmorillonite, or montmorillonite and hectorite in an amount from 0.5 to 4 wt. %, such as 1.0 to 4 wt. %, such as 1.0 to 3.5 wt. %; b) xanthan gum; and c) an antioxidant.

It is contemplated that the xanthan gum is present in the thixotropic aqueous mixture in an amount from 0.2 to 5.5 wt. %, optionally from 0.2 to 0.5 wt. % or from 4.5 to 5.5 wt. %. Thus, in some embodiments, the thixotropic aqueous mixture comprises: a) smectite clay; b) xanthan gum in an amount from 0.2 to 5.5 wt. %, such as 0.2 to 0.5 wt. % or 4.5 to 5.5 wt. %; and c) an antioxidant.

Therefore, in some embodiments, the invention provides a thixotropic aqueous mixture comprising: a) smectite clay in an amount from 0.5 to 4 wt. %, such as 1.0 to 4 wt. %, such as 1.0 to 3.5 wt. %; b) xanthan gum in an amount from 0.2 to 5.5 wt. %, such as 0.2 to 0.5 wt. % or 4.5 to 5.5 wt. %; and c) an antioxidant. For example, the thixotropic aqueous mixture may comprise: a) montmorillonite, or montmorillonite and hectorite, in an amount from 0.5 to 4 wt. %, such as 1.0 to 4 wt. %, such as 1.0 to 3.5 wt. %; b) xanthan gum in an amount from 0.2 to 5.5 wt. %, such as 0.2 to 0.5 wt. % or 4.5 to 5.5 wt. %; and c) an antioxidant.

In some embodiments, the ratio of at least one smectite clay to xanthan gum is from 10:1 to 1:3, such as from 8:1 to 1:4, such as about 4:1.

The antioxidant may be sodium citrate. Thus, in some embodiments, the invention provides a thixotropic aqueous mixture comprising: a) smectite clay; b) xanthan gum; and c) and sodium citrate. For example, the thixotropic aqueous mixture may comprise: a) montmorillonite, or montmorillonite and hectorite; b) xanthan gum; and c) and sodium citrate. It is contemplated that the antioxidant (e.g., sodium citrate) is present in the mixture in an amount from, for example, 0.1 to 0.3 wt. %, optionally at about 0.2 wt. %.

Therefore, in some embodiments, the invention provides a thixotropic aqueous mixture comprising: a) smectite clay in an amount from 0.5 to 4 wt. %, such as 1.0 to 4 wt. %, such as 1.0 to 3.5 wt. %; b) xanthan gum in an amount from 0.2 to 5.5 wt. %, such as 0.2 to 0.5 wt. % or 4.5 to 5.5 wt. %; and c) an antioxidant (e.g. sodium citrate) in an amount from 0.1 to 0.3 wt. %, optionally at about 0.2 wt. %. For example, the thixotropic aqueous mixture may comprise: a) smectite clay in an amount from 0.5 to 4 wt. %, such as 1.0 to 4 wt. %, such as 1.0 to 3.5 wt. %; b) xanthan gum in an amount from 0.2 to 5.5 wt. %, such as 0.2 to 0.5 wt. % or 4.5 to 5.5 wt. %; and c) sodium citrate in an amount from 0.1 to 0.3 wt. %, optionally at about 0.2 wt. %. For example, the thixotropic aqueous mixture may comprise: a) montmorillonite, or montmorillonite and hectorite, in an amount from 0.5 to 4 wt. %, such as 1.0 to 4 wt. %, such as 1.0 to 3.5 wt. %; b) xanthan gum in an amount from 0.2 to 5.5 wt. %, such as 0.2 to 0.5 wt. % or 4.5 to 5.5 wt. %; and c) sodium citrate in an amount from 0.1 to 0.3 wt. %, optionally at about 0.2 wt. %.

It is contemplated that the total solids content of the thixotropic aqueous mixture is between 1 and 7% solids, optionally from 3.5% to 7% solids, such as about 4% solids.

There is also provided a method of making a thixotropic aqueous mixture, comprising mixing at least one smectite clay, xanthan gum, and an antioxidant with water under high shear to form the thixotropic aqueous mixture. The at least one smectite clay, xanthan gum, and an antioxidant are as defined above in the context of the thixotropic aqueous mixture of the invention. Accordingly, in some embodiments, the at least one smectite clay is montmorillonite, or montmorillonite and hectorite; and/or the antioxidant is sodium citrate.

In some embodiments, the at least one smectite clay, the xanthan gum, and/or the sodium citrate are combined in powder form, and then the combined powders are mixed with water under high shear. Alternatively, the at least one smectite clay, the xanthan gum, and the sodium citrate are added separately (simultaneously, or sequentially) to water during high shear mixing. High shear mixing steps, and suitable apparatus, are as defined herein.

There is also provided a thixotropic aqueous mixture prepared by the method of the invention. In some embodiments, the high shear method of making a thixotropic aqueous mixture of the invention further comprises applying said thixotropic aqueous mixture to the surface of produce.

There is also provided a method of protecting produce from dehydration and/or oxidation, comprising applying the thixotropic aqueous mixture of the invention to the surface of produce. There is also provided a method of delaying ripening of produce, comprising applying the thixotropic aqueous mixture of the invention to the surface of the produce, whereby ripening is delayed as compared to the ripening of produce to which the mixture is not applied. There is also provided a method of extending the shelf life of produce, comprising applying the thixotropic aqueous mixture of the invention to the surface of the produce, whereby the shelf life is extended as compared to the ripening of produce to which the mixture is not applied. The invention also provides corresponding uses of a thixotropic aqueous mixture of the invention. Protecting produce from dehydration and/or oxidation, delaying ripening of produce, and extending the shelf life of produce, and methods for their measurement, are as defined herein.

In any of the methods of the invention that comprise applying a thixotropic aqueous mixture of the invention to the surface of produce, the produce and the produce surface is as defined herein. For example, the produce is fruit, optionally pome fruit.

In any of the methods of the invention that comprise applying a thixotropic aqueous mixture of the invention to the surface of produce, the mixture may be applied using a dip tank, spray bar, or brush bed, or any combination thereof; optionally using a combination of spray bar and brush bed, or using a combination of dip tank and brush bed. For example, in some embodiments, the thixotropic aqueous mixture is applied using a spray bar at a spray rate in the range of 1000 to 10,000 pounds of produce per liter of thixotropic aqueous mixture, optionally in the range of 5000 to 8,000 pounds of produce per liter of thixotropic aqueous mixture, optionally at about 7000 pounds of produce per liter of thixotropic aqueous mixture.

### Further Aspects of the Invention

It has been unexpectedly discovered that mixtures of certain water-soluble polymers, smectite clays and glycerophospholipid that form highly thixotropic fluids in water when coated on produce increase the shelf life and ready eat window much more effectively than previous self-assembling coatings. Further, it has been unexpectedly discovered that mixtures of certain water-soluble polymers, smectite clays, and glycerophospholipid and/or polysaccharides that form highly thixotropic fluids in water when coated on produce increase the shelf life and ready to eat window. The thixotropic mixtures of the present invention form a very thin coating on produce such as fruits and vegetables that extends the shelf life and ready to eat window of the produce with much lower concentration and dose than previous technology. The new formulation has a much lower percent by weight of solids and therefore dries to a very thin coating which doesn't change the appearance or tactile feel of the fruit.

In an embodiment of the present invention, the mixture is comprised of at least one smectite clay, a water-soluble polymer and a glycerophospholipid. For example, it is contemplated that the mixture is an organic thixotropic aqueous mixture to increase shelf life and ready to eat window of produce, comprising at least one smectite clay, a water-soluble polymer and a glycerophospholipid.

The at least one smectite clay component may include without limitation, sodium montmorillonite, hectorite, or Laponite, or mixtures thereof; such as sodium montmorillonite, sodium hectorite, or Laponite, and mixtures thereof. The contemplated water-soluble polymers include polyvinyl alcohol (PVOH), gum Arabic, pullulan, and pectin, or combinations thereof. In some embodiments, the water-soluble polymer is PVOH, gum Arabic, or pectin, or mixtures thereof. It is contemplated that the glycerophospholipid may include without limitation lecithin from various sources such as soy, sunflower, egg, etc. One of the preferred embodiments of the composition is sodium montmorillonite, food grade polyvinyl alcohol (PVOH) and sunflower lecithin.

In an embodiment of the invention, the coating composition comprises at least one smectite clay in an amount from 0.5 to 4.5 weight % by volume of the total composition. In another embodiment of the coating composition of the present invention, the composition comprises a water-soluble polymer in an amount from 0.5 to 4.5 weight % by volume of the total composition. In another embodiment of the coating composition of the present invention, the composition comprises a lecithin in an amount from 0.5 to 2.5% weight of the total composition. Various ratios of at least one smectite clay to water-soluble polymer are contemplated herein. In one embodiment, the at least one smectite clay to water-soluble polymer ratio of the composition is between 1:4 and 4:1. In another embodiment, the at least one smectite clay to water-soluble polymer ratio of the composition is to 1:1. In yet another embodiment, the aqueous dispersion of the composition is between 1 and 7% solids, such as between 1 and 6% solids.

This composition does not contain any components that would change the organic status of the fruit, nor does it require additional components to achieve the desired outcome. Thus, in some embodiments, the composition described herein is a novel composition to increase shelf life and the ready to eat window that is edible and organic.

The invention also provides methods of making a thixotropic mixture of the invention, and applying said mixture to produce. For example, the invention provides methods of making thixotropic mixtures comprising at least one smectite clay, glycerophospholipid, and water-soluble polymer, and applying said mixture to fruits. The at least one smectite clay, water-soluble polymer, and glycerophospholipid are added with high shear mixing to water then applied to produce via a tank, spray bar, or brush bed or combination thereof. For example, the at least one smectite clay, water-soluble polymer and food grade lecithin are added with high shear mixing to water then applied to produce via a tank, spray bar, or brush bed or combination thereof. This method of coating produce with the at least one smectite clay, water-soluble polymer, and glycerophospholipid (e.g., lecithin) composition increases the shelf life and ready to eat window.

The invention further provides methods of making thixotropic mixtures comprising at least one smectite clay, glycerophospholipid, water-soluble polymer and/or polysaccharide, and applying said mixture to fruits. The invention further provides a method of applying a thixotropic mixture comprising water-soluble polymer, smectite clay, and glycerophospholipid and/or polysaccharide that form a very highly oriented thin coating on fruits and vegetables that extend the shelf life and ready to eat window with improved efficacy and low dosage. In an embodiment of the invention, the components of the compositions are premixed in powder form and then the mixture is added to water with high shear mixing. In another embodiment of the invention, the components of the composition are added separately to water with high shear mixing.

The composition of the present invention can be applied via a tank, spray bar, or brush bed or other method that completely coats the produce with the thixotropic mixture. Therefore, there is provided a method of applying a thixotropic aqueous mixture of the invention to the surface of produce, wherein the composition is applied in a dip tank, spray bar, or brush bed or any combination thereof. The preferred method of application of the coating to the produce in the disclosed composition is a combination of spray bar and brush bed to increase the comprehensiveness of the coating. Efficacy can be greatly improved and coating thickness minimized by utilizing a combination of spray bar and brush bed for application to produce. Therefore, there is provided a method of applying a thixotropic aqueous mixture of the invention to the surface of produce to increase shelf life and ready to eat window wherein the composition is applied in a combination spray bar and brush bed. There is also provided a method of coating an organic thixotropic aqueous mixture to increase shelf life and ready to eat window of produce comprising a combination of spray bar and brush bed. In an embodiment of the invention, fruits (e.g., pome fruits) are sprayed after the dip tank and before the brush bed. In some embodiments, the rate of spray ranges from 1000 pounds/liter to 7000 pounds/liter of treated fruit. In the application stage, the shear imparted by the pump and spray nozzles lowers the viscosity of the fluid and lessens the resistance to flow. Once the spray impinges upon the fruit surface the viscosity recovers and forms a fairly uniform coating on the fruit. The produce thus coated passes over a brush bed that ensures that the fruit is uniformly coated but in addition the shear that the brushes apply to the coating lowers the viscosity of the coating and orients the plates of nanoclay parallel to the fruit surface. This action aids in the formation of a highly oriented self-assembled barrier coating with extremely high efficacy.

The method of applying the coating composition on the fruit can be done either pre-harvest or post-harvest. The maximum effect is seen when the coating is applied pre-harvest but substantial effect on shelf life and ready to eat window is also seen if fruit is coated after storage.

The invention takes advantage of the thixotropic character of the self-assembling coating and large aspect ratio of the nanoclay contained therein.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

### EXAMPLES

### Example 1: Thixotropic Compositions for Extending D'Anjou Pear Shelf Life

A laboratory scale trial was conducted wherein a control self-assembling composition was compared to a thixotropic composition of the present invention. The control composition had a total solids content of 7.4% by weight consisting of 1.2% laponite, 1.5% montmorillonite, 4.2% polyvinyl alcohol (PVOH), 0.5% sodium citrate. The composition of this invention had 0.576% laponite, 0.72% montmorillonite, 2.0% lecithin (from sunflowers), 2.02% PVOH, and 0.252% sodium citrate, with a total percent by weight solids of 5.5%. The two formulae were utilized to coat D'Anjou pears employing a paint spray gun at the same volume of spray. The pears were then monitored for the transition from green to yellow. This color change is an indication of over ripeness. The control coated group lasted 10 days while the fruit coated with the composition of this invention lasted 13 days. This is a 30% increased shelf life as compared to the control coated group, achieved using a formula with 26% less solids.

### Example 2: Applying Thixotropic Compositions to Extend Bartlett Pears Shelf Life

A thixotropic composition containing montmorillonite, Laponite, polyvinyl alcohol, and lecithin was applied to pears in two ways. The first was via a dip tank and second was a combination of spray bar and brush bed. In the test the amount of fruit coated per liter was determined and the amount of shelf life extension was determined using color change and pressure measurements. The pears utilized in the test were Bartletts. In the case of the dip tank coated fruit the dose rate was determined to be 500 pounds of fruit per liter. The shelf life extension was six days longer than control pears lacking any coating. In the pears coated with a spray bar and brush bed combination the optimum dose rate was 7000 pounds per liter. The shelf life extension was eight days longer than the uncoated control.

### Example 3: Extending Shelf Life of Argentina Packham Triumph Pears

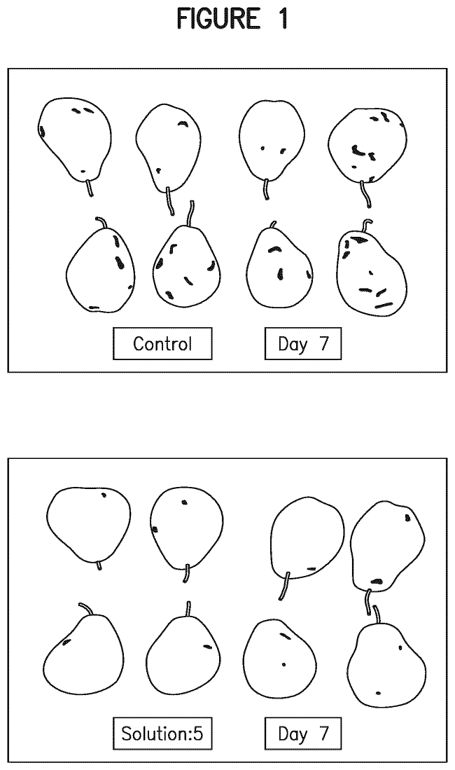

In this example, a common pear in Argentina, Packham Triumph, were coated in a thixotropic 4.5% aqueous dispersion containing 0.945% bentonite, 1.48% polyvinyl alcohol, 1.89% lecithin, and 0.18% sodium citrate applied by dipping. The pears were stored at room temperature for seven days. The coated fruit has delayed color change which relates to ripening. FIG. 1 shows that compared to uncoated controls, the coated pears better retained an appealing green color and showed less signs of damage on the skin.

### Example 4: Thixotropic Coatings to Prevent Dehydration in Gala Apples

A test was conducted to measure the effects of compositional changes to the thixotropic mixture of the invention on improving the shelf life of coated organic gala apples. In this test, 13 different thixotropic aqueous mixtures comprising various proportions of Montmorillonite (MMT), Hectorite, Lecithin, Xanthan Gum, and Citrate were used to coat organic Gala Apples. The mixtures were applied by hand, to simulate a high shear spray and brush bed. The compositions of the mixtures S1-S13 are detailed in Table 1.

TABLE 1

| | MMT | | | Xanthan Gum | | Hectorite | | Lecithin | | Citrate | |
|---|---|---|---|---|---|---|---|---|---|---|---|
| Sample | weight | | wt. % | weight | wt. % | weight | wt. % | weight | wt. % | weight | wt. % |
| S1 | 13.9 | g | 1.39% | 3.0 g | 0.3% | | | 19.0 g | 1.9% | 2.0 g | 0.2% |
| S2 | 12.7 | g | 1.27% | 3.0 g | 0.3% | | | 19.0 g | 1.9% | 2.0 g | 0.2% |
| S3 | 12.7 | g | 1.27% | 4.0 g | 0.4% | | | 19.0 g | 1.9% | 2.0 g | 0.2% |
| S4 | 12.7 | g | 1.27% | 5.0 g | 0.5% | | | 19.0 g | 1.9% | 2.0 g | 0.2% |
| S5 | 12.7 | g | 1.27% | 3.0 g | 0.3% | | | 16.0 g | 1.6% | 2.0 g | 0.2% |
| S6 | 12.7 | g | 1.27% | 3.0 g | 0.3% | | | 23.0 g | 2.3% | 2.0 g | 0.2% |
| S7 | 13.9 | g | 1.39% | 4.0 g | 0.4% | | | 19.0 g | 1.9% | 2.0 g | 0.2% |
| S8 | 12.7 | g | 1.27% | 4.0 g | 0.4% | | | 16.0 g | 1.6% | 2.0 g | 0.2% |
| S9 | 12.7 | g | 1.27% | 4.0 g | 0.4% | | | 23.0 g | 2.3% | 2.0 g | 0.2% |
| S10 | 13.9 | g | 1.39% | 5.0 g | 0.5% | | | 19.0 g | 1.9% | 2.0 g | 0.2% |
| S11 | 12.7 | g | 1.27% | 5.0 g | 0.5% | | | 23.0 g | 2.3% | 2.0 g | 0.2% |
| S12 | 12.7 | g | 1.27% | 5.0 g | 0.5% | | | | | 2.0 g | 0.2% |
| S13 | 15 | g | 1.5% | 0.4 g | 0.04% | 18 g | 1.8% | | | 2.0 g | 0.2% |

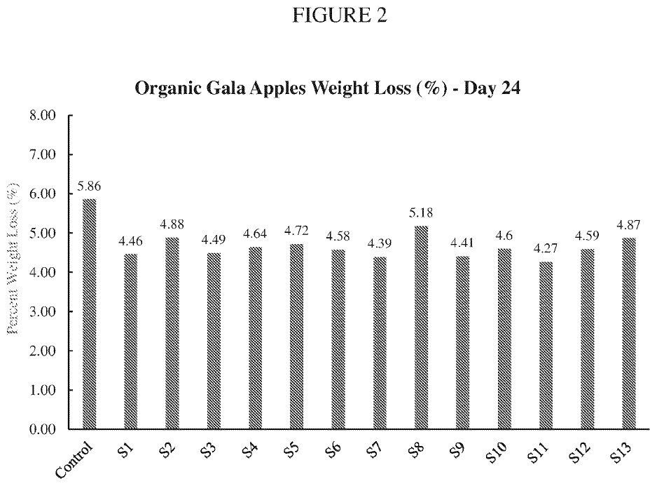

After 24 days, the apples were weighed to assess dehydration of the fruit, which contributes to spoiling. The average weights of each sample of apples are summarized in Table 2 and FIG. 2. Apples coated in one of the 13 mixtures had on average 11%-27% improved water retention compared to uncoated controls. Samples S7 and S11 had the most improved % water retention.

TABLE 2

| | Weight Loss | Weight Retention |
|---|---|---|
| | (%) Day 24 | W.R.T. Control (%) |
| Control (Uncoated) | 5.86 | Day 24 |
| S1 | 4.46 | 23.89 |
| S2 | 4.88 | 16.72 |
| S3 | 4.49 | 23.38 |
| S4 | 4.64 | 20.82 |
| S5 | 4.72 | 19.45 |
| S6 | 4.58 | 21.84 |
| S7 | 4.39 | 25.09 |
| S8 | 5.18 | 11.60 |
| S9 | 4.41 | 24.74 |
| S10 | 4.6 | 21.50 |
| S11 | 4.27 | 27.13 |
| S12 | 4.59 | 21.67 |
| S13 | 4.87 | 16.89 |

### Example 5: Thixotropic Coatings to Prevent Dehydration in Bartlett Pears

A test was conducted to measure the effects of compositional changes to the thixotropic mixture of the invention on improving the shelf life of coated Bartlett Pears. In this test, 8 different thixotropic mixtures comprising various proportions of Montmorillonite (MMT), Lecithin, Gum Arabic, and Citrate were utilized to coat Bartlett pears. The mixtures were applied by hand, to simulate a high shear spray and brush bed application method. The compositions of the mixtures S14-23 are detailed in Table 3.

TABLE 3

| | MMT | | Gum Arabic | | | Lecithin | | | Citrate | |
|---|---|---|---|---|---|---|---|---|---|---|
| Sample | weight | wt. % | weight | | wt. % | weight | | wt. % | weight | wt. % |
| S14 | 37.5 g | 3.75% | 11.25 | g | 1.125% | 26.25 | g | 2.625% | 2.0 g | 0.2% |
| S15 | 38.1 g | 3.81% | 15.0 | g | 1.5% | 27.0 | g | 2.7% | 2.0 g | 0.2% |
| S16 | 36.0 g | 3.6% | 12.0 | g | 1.2% | 33.0 | g | 3.3% | 2.0 g | 0.2% |
| S17 | 29.0 g | 2.9% | 12.0 | g | 1.2% | 33.0 | g | 3.3% | 2.0 g | 0.2% |
| S18 | 23.0 g | 2.3% | 12.0 | g | 1.2% | 33.0 | g | 3.3% | 2.0 g | 0.2% |
| S19 | 23.0 g | 2.3% | 9.0 | g | 0.9% | 19.0 | g | 1.9% | 2.0 g | 0.2% |
| S20 | 40.0 g | 4.0% | 12.0 | g | 1.2% | 29.0 | g | 2.9% | 2.0 g | 0.2% |
| S21 | 40.0 g | 4.0% | 16.0 | g | 1.6% | 29.0 | g | 2.9% | 2.0 g | 0.2% |
| S22 | 50.0 g | 5.0% | | | | 36.0 | g | 3.6% | 2.0 g | 0.2% |
| S23 | 60.0 g | 6.0% | | | | 23.0 | g | 2.3% | 2.0 g | 0.2% |

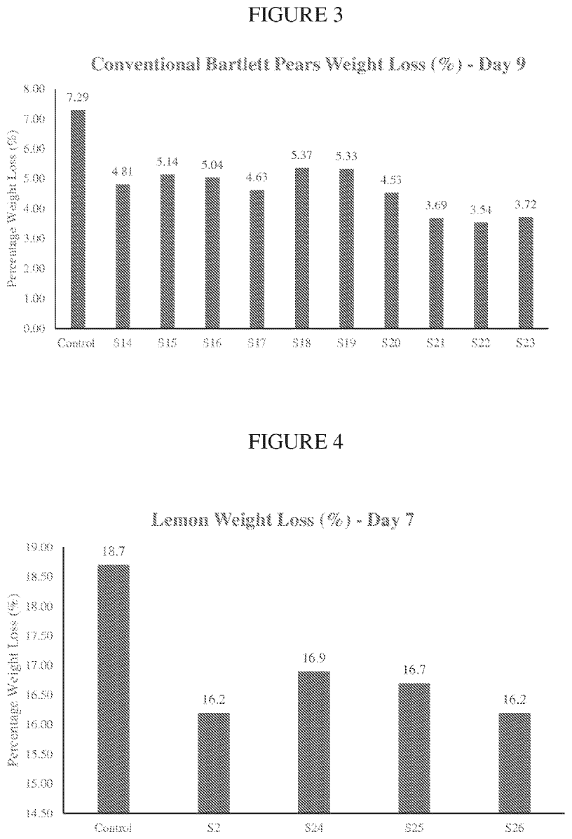

After 4, 7 and 9 days, the pears were weighed to assess dehydration of the fruit, which contributes to spoiling. The average weights of each sample of Bartlett pears are summarized in Table 4 and FIG. 3. Pears coated in one of the 8 mixtures had on average 29%-49% improved water retention compared to uncoated controls after 9 days. The samples with the most improved % water retention compared to the control were S21 and S22.

TABLE 4

| | | | | Weicht Retention W.R.T. | | |
|---|---|---|---|---|---|---|
| | Weight Loss (%) | Weight Loss (%) | Weight Loss (%) | Control (%) | | |
| | Day 5 | Day 7 | Day 9 | Day 5 | Day 7 | Day 9 |
| Uncoated | 3.09 | 5.28 | 7.29 | | | |
| Control | | | | | | |
| S14 | 2.05 | 3.51 | 4.81 | 33.67 | 33.50 | 34.10 |
| S15 | 2.25 | 3.75 | 5.14 | 27.12 | 28.95 | 29.51 |
| S16 | 2.13 | 3.64 | 5.04 | 31.19 | 31.14 | 30.91 |
| S17 | 1.95 | 3.34 | 4.63 | 36.97 | 36.82 | 36.49 |
| S18 | 2.31 | 3.90 | 5.37 | 25.44 | 26.16 | 26.39 |
| S19 | 2.34 | 3.90 | 5.33 | 24.33 | 26.20 | 26.98 |
| S20 | 1.97 | 3.29 | 4.53 | 36.26 | 37.63 | 37.84 |
| S21 | 1.54 | 2.45 | 3.69 | 50.28 | 51.43 | 49.45 |
| S22 | 1.48 | 2.35 | 3.54 | 52.04 | 53.31 | 51.51 |
| S23 | 1.57 | 2.51 | 3.72 | 49.13 | 50.27 | 49.04 |

### Example 6: Thixotropic Coatings to Prevent Dehydration in Lemons

A test was conducted to measure the effects of compositional changes to the thixotropic mixture of the invention on improving the shelf life of coated lemons. In this test, 4 different thixotropic mixtures comprising various proportions of Montmorillonite (MMT), Lecithin, Citrate and either Xanthan gum or gum Arabic were utilized to coat lemons. The compositions of the mixtures S2 and S24-S26 are detailed in Table 5.

TABLE 5

| | MMT | | Gum Arabic | | | Xanthan Gum | | Lecithin | | | Citrate | |
|---|---|---|---|---|---|---|---|---|---|---|---|---|
| Sample | weight | wt. % | weight | | wt. % | weight | wt. % | weight | | wt. % | weight | wt. % |
| S2 | 12.7 g | 1.27% | | | | 3.0 g | 0.3% | 19.0 | g | 1.9% | 2.0 g | 0.20% |
| S24 | 12.7 g | 1.27% | | | | | | 19.0 | g | 1.9% | 2.0 g | 0.2% |
| S25 | 12.7 g | 1.27% | 5 | g | 0.5% | | | 9.0 | g | 0.9% | 2.0 g | 0.2% |
| S26 | 16.0 g | 1.6% | 36.0 | g | 3.6% | | | 23.0 | g | 2.3% | 2.0 g | 0.2% |

After 3, 5 and 7 days, the lemons were weighed to assess dehydration of the fruit, which contributes to spoiling. The average weight of each sample of lemons is summarized in Table 6 and FIG. 4. Lemons coated in one of the 4 mixtures had on average 24%-27.5% improved water retention compared to uncoated controls after 3 days, and on average 9%-13% improved water retention compared to uncoated controls after 7 days. Sample S2 had the most improved % water retention.

TABLE 6

| | | | | Weight Retention W.R.T. | | |
|---|---|---|---|---|---|---|
| | Weight Loss (%) | Weight Loss (%) | Weight Loss (%) | Control (%) | | |
| | Day 3 | Day 5 | Day 7 | Day 3 | Day 5 | Day 7 |
| Uncoated | 8.00 | 13.50 | 18.70 | | | |
| Control | | | | | | |
| S2 | 5.80 | 10.70 | 16.20 | 27.50 | 20.74 | 13.37 |
| S24 | 5.90 | 10.90 | 16.90 | 26.25 | 19.26 | 9.63 |
| S25 | 6.10 | 11.20 | 16.70 | 23.75 | 17.04 | 10.70 |
| S26 | 6.00 | 11.10 | 16.20 | 25.00 | 17.78 | 13.37 |

The test was also carried out on lemons coated with thixotropic compositions comprising montmorillonite, optionally Laponite (LAP), PVOH, lecithin, and citrate; wherein the compositions S27 and S28 were formulated as detailed in Table 7.

TABLE 7

| | MMT | | Laponite | | | PVOH | | Lecithin | | Citrate | |
|---|---|---|---|---|---|---|---|---|---|---|---|
| Sample | weight | wt. % | weight | | wt. % | weight | wt. % | weight | wt. % | weight | wt. % |
| S27 | 8.0 g | 0.8% | 8.0 | g | 0.8% | 25.0 g | 2.5% | 29.0 g | 2.9% | 2.0 g | 0.20% |
| S28 | | | 11.0 | g | 1.1% | 21.0 g | 2.1% | 23.0 g | 2.3% | 2.0 g | 0.2% |

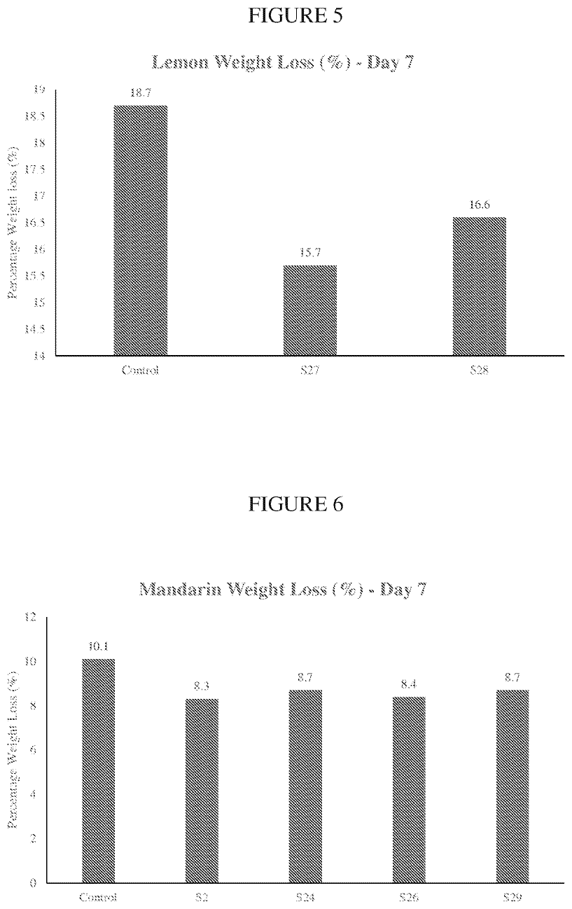

After 3, 5 and 7 days, the lemons were weighed to assess dehydration of the fruit. The average weight of each sample of lemons is summarized in Table 8 and FIG. 5. Lemons coated in either of the two mixtures had on average 26%-27.5% improved water retention compared to uncoated controls after 3 days, and on average 11%-16% improved water retention compared to uncoated controls after 7 days. The sample with the most improved % water retention was S27.

TABLE 8

| | | | | Weight Retention W.R.T. | | |
|---|---|---|---|---|---|---|
| | Weight Loss (%) | Weight Loss (%) | Weight Loss (%) | Control (%) | | |
| | Day 3 | Day 5 | Day 7 | Day 3 | Day 5 | Day 7 |
| Uncoated | 8.00 | 13.50 | 18.70 | | | |
| Control | | | | | | |
| S27 | 5.80 | 10.80 | 15.70 | 27.50 | 20.00 | 16.04 |
| S28 | 5.90 | 10.90 | 16.60 | 26.25 | 19.26 | 11.23 |

### Example 7: Thixotropic Coatings to Prevent Dehydration in Mandarins

A test was conducted to measure the effects of compositional changes to the thixotropic mixture of the invention on improving the shelf life of coated mandarins. In this test, 4 different thixotropic mixtures comprising various proportions of Montmorillonite (MMT), Lecithin, Citrate, and Xanthan gum or gum Arabic were utilized to coat mandarins. The compositions of the mixtures S2, S24, S26 and S29 are detailed in Table 9.

TABLE 9

| | MMT | | Gum Arabic | | Xanthan Gum | | Lecithin | | Citrate | |
|---|---|---|---|---|---|---|---|---|---|---|
| Sample | weight | wt. % | weight | wt. % | weight | wt. % | weight | wt. % | weight | wt. % |
| S2 | 12.7 g | 1.27% | | | 3.0 g | 0.3 g | 19.0 g | 1.9% | 2.0 g | 0.2% |
| S24 | 12.7 g | 1.27% | | | | | 19.0 g | 1.9% | 2.0 g | 0.2% |
| S26 | 16.0 g | 1.6% | 36.0 g | 3.6% | | | 23.0 g | 2.3% | 2.0 g | 0.2% |
| S29 | 12.7 g | 1.27% | 63.0 g | 6.3% | | | 19.0 g | 1.9% | 2.0 g | 0.2% |

After 3, 5 and 7 days, the mandarins were weighed to assess dehydration of the fruit. The average weight of each sample of mandarins are summarized in Table 10 and FIG. 6. Mandarins coated in either of the two mixtures had on average 14%-19% improved water retention compared to uncoated controls after 3 days, and on average 14%-18% improved water retention compared to uncoated controls after 7 days. Sample S2 had the most improved % water retention.

TABLE 10

| | | | | Weight Retention W.R.T. | | |
|---|---|---|---|---|---|---|
| | Weight Loss (%) | Weight Loss (%) | Weight Loss (%) | Control (%) | | |
| | Day 3 | Day 5 | Day 7 | Day 3 | Day 5 | Day 7 |
| Uncoated | 3.60 | 6.50 | 10.10 | | | |
| Control | | | | | | |
| S2 | 2.90 | 5.40 | 8.30 | 19.44 | 16.92 | 17.82 |
| S25 | 3.10 | 5.70 | 8.70 | 13.89 | 12.31 | 13.86 |
| S27 | 3.00 | 5.50 | 8.40 | 16.67 | 15.38 | 16.83 |
| S30 | 3.10 | 5.60 | 8.70 | 13.89 | 13.85 | 13.86 |

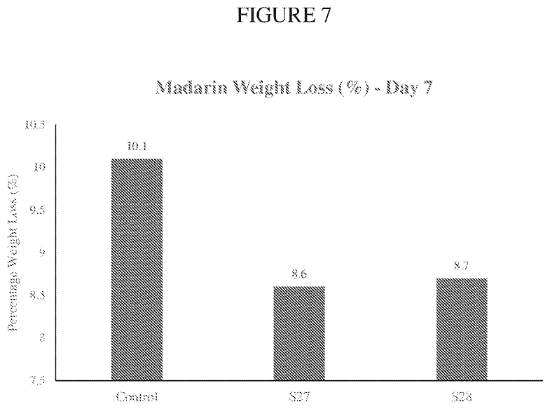

The test was also carried out on mandarins coated with thixotropic compositions S27 and S28 formulated as detailed in Table 7 for the lemon coatings. After 3, 5 and 7 days, the mandarins were weighed to assess dehydration of the fruit. The average weight of each sample of mandarins is summarized in Table 11 and FIG. 7. Mandarins coated in either of the two mixtures had on average 19%-22% improved water retention compared to uncoated controls after 3 days, and on average 14-15% improved water retention compared to uncoated controls after 7 days. The sample with the most improved % water retention was S27.

TABLE 11

| | | | | Weight Retention W.R.T. | | |
|---|---|---|---|---|---|---|
| | Weight Loss (%) | Weight Loss (%) | Weight Loss (%) | Control (%) | | |
| | Day 3 | Day 5 | Day 7 | Day 3 | Day 5 | Day 7 |
| Uncoated | 3.60 | 6.50 | 10.10 | | | |
| Control | | | | | | |
| S27 | 2.80 | 5.60 | 8.60 | 22.22 | 13.85 | 14.85 |
| S28 | 2.90 | 5.70 | 8.70 | 19.44 | 12.31 | 13.86 |

### Example 8: Thixotropic Coatings to Prevent Dehydration in Cherries

In this test, 3 different thixotropic mixtures comprising various proportions of Montmorillonite (MMT), Xanthan Gum, Lecithin, and Citrate were utilized to coat cherries. The compositions of the mixtures S30 and S31 are detailed in Table 12.

| | MMT | | Xanthan Gum | | Lecithin | | Citrate | |
|---|---|---|---|---|---|---|---|---|
| Sample | weight | wt. % | weight | wt. % | weight | wt. % | weight | wt. % |
| S30 | 12.7 g | 1.27% | | | 19.0 g | 1.9% | 2.0 g | 0.24% |
| S31 | 12.7 g | 1.27% | 7.0 g | 0.7% | 12.0 g | 1.2% | 2.0 g | 0.2% |

We claim:

1. A thixotropic aqueous mixture for protecting produce from dehydration and/or oxidation, comprising:
a) smectite clay; and
b) a glycerophospholipid.

2. The thixotropic aqueous mixture of claim 1, wherein the smectite clay is montmorillonite, Laponite, or bentonite, or montmorillonite and Laponite.

3. The thixotropic aqueous mixture of claim 1 or claim 2, wherein the glycerophospholipid is lecithin; optionally wherein the lecithin is or is derived from soy lecithin, sunflower lecithin, or egg lecithin.

4. The thixotropic aqueous mixture of any one of claims 1-3, wherein the smectite clay is present in the thixotropic aqueous mixture in an amount from 0.5 to 6.5 wt. %, optionally from 1.0 to 5.0 wt. %, optionally from 1.0 to 1.5 wt. %.

5. The thixotropic aqueous mixture of any one of claims 1-4, wherein the glycerophospholipid is present in the thixotropic aqueous mixture in an amount from 0.5 to 4.0 wt. %, optionally from 1.5 to 3.5 wt. %, optionally from 1.5 to 2.5 wt. %.

6. The thixotropic aqueous mixture of any one of claims 1-5, wherein the ratio of the smectite clay to the glycerophospholipid is from 3:1 to 0.3:1 (w/w), optionally from 1.5:1 to 0.5:1, or from 1:1 to 0.5:1; optionally at about 0.7:1 (w/w).

7. The thixotropic aqueous mixture of any one of claims 1-6, further comprising an antioxidant; optionally wherein the antioxidant is sodium citrate.

8. The thixotropic aqueous mixture of claim 7, wherein the antioxidant is present in the mixture in an amount from 0.05 to 0.5 wt. %, optionally from 0.1 to 0.3 wt. %.

9. The thixotropic aqueous mixture of claim 7 or claim 8, comprising:
a) smectite clay;
b) lecithin; and
c) sodium citrate.

10. The thixotropic aqueous mixture of any one of claims 1-9, further comprising a water-soluble polymer.

11. The thixotropic aqueous mixture of claim 10, wherein the water-soluble polymer is PVOH.

12. The thixotropic aqueous mixture of claim 11, comprising:
a) smectite clay;
b) lecithin;
c) PVOH; and
d) sodium citrate.

13. The thixotropic aqueous mixture of claim 12, wherein the smectite clay is bentonite, Laponite, or montmorillonite and Laponite.

14. The thixotropic aqueous mixture of any one of claims 11-13, wherein the PVOH is present in the mixture in an amount from 1.0 to 3.0 wt. %, optionally from 1.5 to 2.5 wt. %, optionally at about 2.0 wt. %.

15. The thixotropic aqueous mixture of claim 10, wherein the water-soluble polymer comprises one or more polysaccharide.

16. The thixotropic aqueous mixture of claim 15, wherein the polysaccharide is xanthan gum or gum Arabic.

17. The thixotropic aqueous mixture of claim 16, comprising:
a) smectite clay;
b) lecithin;
c) xanthan gum or gum Arabic; and
d) sodium citrate.

18. The thixotropic aqueous mixture of claim 17, wherein the smectite clay is montmorillonite or Laponite.

19. The thixotropic aqueous mixture of any one of claims 15-18, wherein the one or more polysaccharide is present in the mixture in an amount from 0.2 to 6.5 wt. %;
optionally wherein xanthan gum is present in the mixture in an amount from 0.2 to 0.6 wt. %;
optionally wherein gum Arabic is present in the mixture in an amount from 0.2 to 2.0 wt. %, optionally from 0.5 to 2.0 wt. %.

20. The thixotropic aqueous mixture of any one of claims 1-19, wherein the total solids content of the thixotropic aqueous mixture is between 2 and 10% solids, optionally between 3 and 6% solids, optionally between 3.5 and 5.5% solids.

21. A method of making a thixotropic aqueous mixture, comprising mixing at least one smectite clay and a glycerophospholipid with water under high shear to form a thixotropic aqueous mixture.

22. The method of claim 21, wherein:
the at least one smectite clay is montmorillonite, Laponite, bentonite, or montmorillonite and Laponite; and/or
the glycerophospholipid is lecithin.

23. The method of claim 21 or claim 22, wherein:
the at least one smectite clay and the glycerophospholipid are combined in powder form, and then the combined powders are mixed with solvent under high shear; or
the at least one smectite clay and the glycerophospholipid are added separately to the water during high shear mixing.

24. The method of any one of claims 21-23, further comprising mixing sodium citrate with the smectite clay, glycerophospholipid, and water, under high shear.

25. The method of any one of claims 21-23, further comprising mixing a water-soluble polymer with the smectite clay, glycerophospholipid, and water, under high shear; optionally wherein the water-soluble polymer is PVOH or a polysaccharide.

26. A thixotropic mixture prepared by the method of any of claims 21-25.

27. A method, comprising:
i) making a thixotropic aqueous mixture using a high shear method according to any one of claims 21-25; and
ii) applying said thixotropic aqueous mixture to the surface of produce.

28. A method of protecting produce from dehydration and/or oxidation, comprising applying the thixotropic aqueous mixture of any one of claim 1-20 or 26 to the surface of produce.

29. A method of delaying ripening of produce, comprising applying the thixotropic aqueous mixture of any one of claim 1-20 or 26 to the surface of produce, whereby ripening of the produce is delayed compared to ripening of uncoated produce.

30. The method of any one of claims 27-29, wherein the thixotropic aqueous mixture is applied to the surface of produce using a dip tank, spray bar, or brush bed, or any combination thereof;
optionally wherein the thixotropic aqueous mixture is applied using a combination of spray bar and brush bed, or using a combination of dip tank and brush bed;
optionally wherein the thixotropic aqueous mixture is applied using a spray bar at a spray rate in the range of 1000 to 10,000 pounds of produce per liter of thixotropic aqueous mixture; optionally in the range of 5000 to 8,000 pounds of produce per liter of thixotropic aqueous mixture; optionally at about 7000 pounds of produce per liter of thixotropic aqueous mixture.

31. Use of the thixotropic aqueous mixture of any one of claim 1-20 or 26 for protecting produce from dehydration and/or oxidation.

32. Use of the thixotropic aqueous mixture of any one of claim 1-20 or 26 for delaying ripening of produce.

33. The method of any one of claims 27-30, or the use of claim 31 or 32, wherein the produce is fruit, optionally pome fruit or citrus fruit.
